(19) United States
(12) Patent Application Publication
(10) Pub. No.: US 2015/0330121 A1
(43) Pub. Date: Nov. 19, 2015

(54) Integrated Sash Lock and Tilt Latch Combination with Improved Interconnection Capability Therebetween

(71) Applicants: Luke Liang, So. Plainfield, NJ (US); Tong Liang, Guangzhou (CN); David Chen, Guangzhou (CN)

(72) Inventors: Luke Liang, So. Plainfield, NJ (US); Tong Liang, Guangzhou (CN); David Chen, Guangzhou (CN)

(21) Appl. No.: 14/278,226

(22) Filed: May 15, 2014

(51) Int. Cl. E05C 1/16; E05C 3/04

(52) U.S. Cl. CPC E05C 1/16; E05C 3/046

(57) ABSTRACT

A combination sash lock and tilt latch secures a sash window that is slidable and tiltable with respect to a master window frame. The fastener includes a lock assembly and latch assembly. The lock assembly is releasably mounted upon the sash window meeting rail without screws, using legs received within corresponding openings in the rail. The lock assembly is releasably secured thereto by a spring causing engagement between the legs and rail openings. The lock assembly includes a pivotable cam to releasably engage a keeper on the master frame, and a pivotable arm extending into the meeting rail. The latch assembly includes biasing means and a latch member with a plurality of openings, each configured to receive the post of the lock assembly, within the meeting rail, with the lock assembly installed thereon in any one of a plurality of positions corresponding to said openings in said latch member.

### CROSS REFERENCE TO RELATED APPLICATIONS

This application is a continuation-in-part of U.S. patent application Ser. No. 14/198,986, filed on Mar. 6, 2014, the disclosures of which are incorporated herein by reference.

### FIELD OF THE INVENTION

The present invention relates to improvements in locks and tilt latches for slidable sash windows, and more particularly to improvements to an integral sash lock/tilt latch combination.

### BACKGROUND OF THE INVENTION

Single hung and double hung sliding sash windows are commonly used today in the construction of residential and commercial buildings. Sash locks are typically mounted to the meeting rail of the bottom sash window to lock the sash or sashes, by preventing the lower sash (or both the lower and upper sashes for a double hung window), from being opened through sliding movement relative to the master window frame. Also, in order to assist in the cleaning of the exterior of these sliding sash windows, it is common for window manufacturers to incorporate a tilt latch device thereon that permits one end of the sliding sash window to be released from the track of the master window frame. This allows the sash window to be pivoted into the room, for easy access to the exterior surface of the glazing that is normally exposed to the exterior environment of the building.

The present invention seeks to provide improvements to such window hardware in the form of an integrated sash lock and tilt latch fastener for single hung or double hung windows.

### OBJECTS OF THE INVENTION

It is an object of the invention to provide a sash lock to prevent relative sliding movement of one or both sliding sash windows that are slidable within a master window frame.

It is another object of the invention to provide a tilt latch to permit pivoting of a sliding sash window inwardly into the room in which the window is installed.

It is a further object of the invention to provide a combination sash lock and tilt latch that act cooperatively through the use of a single handle member.

It is another object of the invention to provide a sash lock that may be easily installed upon the meeting rail of the sliding sash window without the use of mechanical fasteners, and may also be easily removed therefrom.

It is also an object of the invention to provide a tilt latch device that may be blindly coupled to a sash lock for cooperative interaction and actuation therefrom.

Further objects and advantages of the invention will become apparent from the following description and claims, and from the accompanying drawing figures.

### SUMMARY OF THE INVENTION

An integral sash locking and tilt latching fastener for a sliding sash window includes a lock assembly and a latch assembly. The sash lock assembly is configured to be releasably mounted to the top of the meeting rail of the sash window without screws, and includes a locking cam pivotally mounted to the sash lock housing, and is thereby configured to rotate out from a cavity in the housing to releasably engage a keeper on the master window frame, to inhibit sliding movement of the sash window. The sash lock may also include a pivotable lever arm with a post that is configured to extend beyond the lock housing, and into the hollow of the meeting rail.

The latch may include a biasing means and a latch member that may be slidably received within the side of the meeting rail. The biasing means and latch member may alternatively be received into a latch housing for ease of its installation into the meeting rail. The latch member may include a tongue and a flexible beam extending away from the tongue. The end of the beam distal from the tongue may include a fixed funnel member and a flexible funnel member. The fixed funnel member and the flexible funnel member may be configured to permit the latch assembly to blindly engage the pivotable lever arm of the lock assembly within the meeting rail, when installed therein. The flexible funnel member may deflect during such engagement, so that the post of the pivotal lever arm protruding into the interior hollow of the meeting rail may be received within an opening formed by the fixed funnel member and the flexible funnel member. The biasing member of the latch assembly may be configured to normally bias the latch member so that a portion of the tongue protrudes out from the meeting rail, and simultaneously biases the locking cam of the sash lock towards the latched position.

The locking cam may have a graspable shaft portion that protrudes upwardly, out from an orifice in the sash lock housing, to permit actuation of the device (cam rotation) by a user. Alternatively, the cam may have a separate handle member secured thereto, which may facilitate easy rotation and counter-rotation of the cam.

In addition to being configured to properly engage the key of the keeper to lock the sash to prevent its sliding movement, the locking cam may be configured to selectively drive the pivotable lever arm of the sash lock, and may include three key positions. The locking cam and handle combination may have a first position, in which the sash lock is locked to prevent sliding movement, and the sash latch is latched to prevent pivoting of the sash window. The locking cam and handle combination may have a second position, in which the sash lock is unlocked and the window is free to undergo sliding movement, but the sash latch remains latched to still prevent pivoting of the sash window. The locking cam and handle combination may also have a third position, in which the sash lock is still unlocked and free to undergo sliding movement, but the sash latch is also unlatched, so that the sash window may be pivoted inwardly. Movement of the locking cam and handle combination from the second position to the third position causes the cam to drive the pivotable lever arm to rotate, so that the arm engages the fixed funnel member of the latch assembly, and overcomes the biasing of the latch spring to cause translation of the latch into the retracted position.

The housing of the lock assembly may include one or more hooked legs that are configured to be received within one or more corresponding openings in the top of the meeting rail, for the releasable mounting of the lock assembly thereto, without screws. The lock assembly may be releasably secured in this position by a leaf spring that is fixedly secured to the underneath of the sash lock housing, and which has a portion that protrudes out beyond the sash lock housing to engage in one of the openings in the meeting rail. Removal of the sash lock may be easily accomplished by using a pry tool to deflect the leaf spring from its engagement in the rail opening, to permit appropriate sliding and pivoting of the sash lock assembly to effect removal of its legs from the openings in the meeting rail.

The keeper may be similarly constructed to accomplish its releasable securement to the master window frame, or to the other sash member, which may be slidable (double-hung) or may be fixed (single hung sash window).

### BRIEF DESCRIPTION OF THE DRAWINGS

FIG. 1A is a cross-sectional side view of a left-handed version of the integrated sash lock/tilt latch fastener of the present invention.

FIG. 1B is a cross-sectional side view of a right-handed version of the integrated sash lock/tilt latch fastener of FIG. 1A.

FIG. 2 is a top perspective view of the housing for the sash lock assembly of the integrated sash lock/tilt latch fastener of FIG. 1A.

FIG. 3A is a first perspective view of the interior of the housing of the sash lock assembly of FIG. 1A.

FIG. 3B is a second perspective view of the interior of the housing of the sash lock assembly of FIG. 1A.

FIG. 4 is a front view of the sash lock housing of FIG. 2.

FIG. 5 is a top view of the sash lock housing of FIG. 4.

FIG. 6 is a rear view of the sash lock housing of FIG. 4.

FIG. 7 is a bottom view of the sash lock housing of FIG. 4.

FIG. 8 is a first end view of the sash lock housing of FIG. 4.

FIG. 9 is a second end view of the sash lock housing of FIG. 4.

FIG. 10 is a perspective view of the shaft/handle member of the sash lock assembly of FIG. 1A.

FIG. 11 is a second perspective view of the shaft/handle member of the sash lock assembly of FIG. 1A.

FIG. 12 is a front view of the shaft/handle member of FIG. 10.

FIG. 13 is a top view of the shaft/handle member of FIG. 12.

FIG. 14 is a bottom view of the shaft/handle member of FIG. 12.

FIG. 15 is a first end view of the shaft/handle member of FIG. 12.

FIG. 16 is a second end view of the shaft/handle member of FIG. 12.

FIG. 17 is a perspective view of the locking cam of the sash lock assembly of FIG. 1A.

FIG. 18 is a second perspective view of the locking cam of the sash lock assembly of FIG. 2.

FIG. 19 is a top view of the locking cam of FIG. 17.

FIG. 20 is a first end view of the locking cam of FIG. 19.

FIG. 21 is a second end view of the locking cam of FIG. 19.

FIG. 22 is a bottom view of the locking cam of FIG. 19.

FIG. 23 is a top view of the locking cam of FIG. 19.

FIG. 24 is a bottom view of the locking cam of FIG. 19.

FIG. 25 is a perspective view of the lever arm of the sash lock assembly of FIG. 1A.

FIG. 26 is a second perspective view of the lever arm of the sash lock assembly of FIG. 1A.

FIG. 27 is a top view of the lever arm of FIG. 25.

FIG. 28 is a first end view of the lever arm of FIG. 27.

FIG. 29 is a second end view of the lever arm of FIG. 27.

FIG. 30 is a bottom view of the lever arm of FIG. 27.

FIG. 31 is a front view of the lever arm of FIG. 27.

FIG. 32 is a rear view of the lever arm of FIG. 27.

FIG. 33 is a perspective view of the engagement spring of the sash lock assembly of FIG. 1A.

FIG. 34 is a second perspective view of the engagement spring of the sash lock assembly of FIG. 1A.

FIG. 35 is a front view of the engagement spring of FIG. 33.

FIG. 36 is a top view of the engagement spring of FIG. 35.

FIG. 37 is an end view of the engagement spring of FIG. 35.

FIG. 38 is a perspective view of the detent spring of the sash lock assembly of FIG. 1A.

FIG. 39 is a bottom perspective view of the sash lock assembly of FIG. 1A.

FIG. 40 is a bottom view of the sash lock assembly of FIG. 1A.

FIG. 41 is a front view of the sash lock assembly of FIG. 40.

FIG. 42 is the bottom view of the sash lock assembly of FIG. 40, shown in a reduced size, and with the cam/shaft/handle combination shown in the locked and latched position.

FIG. 43 is the bottom view of FIG. 42, but shown with the cam/handle combination shown in the unlocked and latched position.

FIG. 44 is the bottom view of FIG. 43, but shown with the cam/shaft/handle combination shown in the sash unlocked and unlatched position.

FIG. 45 is the bottom view of FIG. 44, but shown with the cam/shaft/handle combination counter-rotated back into the sash unlocked and latched position.

FIG. 46 is a first perspective view of the housing of the latch assembly of FIG. 1A.

FIG. 47 is a second perspective view of the housing of the latch assembly of FIG. 1A.

FIG. 48 is a third perspective view of the housing of the latch assembly of FIG. 1A.

FIG. 49 is a fourth perspective view of the housing of the latch assembly of FIG. 1A.

FIG. 50 is a front view of the latch housing of FIG. 46.

FIG. 51 is a first end view of the latch housing of FIG. 50.

FIG. 52 is a second end view of the latch housing of FIG. 50.

FIG. 53 is a rear view of the latch housing of FIG. 50.

FIG. 54 is a top view of the latch housing of FIG. 50.

FIG. 55 is a bottom view of the latch housing of FIG. 50.

FIG. 56 is a first perspective view of the latch member of the latch assembly of FIG. 1A.

FIG. 57 is a second perspective view of the latch member of the latch assembly of FIG. 1A.

FIG. 58 is a third perspective view of the latch member of the latch assembly of FIG. 1A.

FIG. 59 is a fourth perspective view of the latch member of the latch assembly of FIG. 1A.

FIG. 60A is a front view of the latch member of FIG. 56, shown with a tongue, and with a dual beam and funnel members.

FIG. 60B is a bottom view of the latch member of FIG. 60A.

FIG. 60C is a top view of the latch member of FIG. 60A.

FIG. GOD is a rear view of the latch member of FIG. 60A.

FIG. 60E is a first end view of the latch member of FIG. 60A.

FIG. 60F is a second end view of the latch member of FIG. 60A.

FIG. 61A is a first perspective view of the latch member of FIG. 56, but with one of the two sets of beams and funnel members having been removed therefrom for a length adjustment.

FIG. 61B is a second perspective view of the singular latch member of FIG. 61A.

FIG. 62 is an exploded view of the parts of the latch assembly of the integrated sash lock/tilt latch fastener of FIG. 1A, including the latch housing, the latch member with two sets of beams and funnel members, and the biasing spring.

FIG. 63 is a side view of the latch assembly formed by the parts shown in FIG. 62.

FIG. 64 is a perspective view of the latch assembly of FIG. 63, shown with the tongue biased into the extended position.

FIG. 65 is a perspective view of the latch assembly of FIG. 64, shown with the tongue in the retracted position.

FIG. 66 is a first perspective view of the keeper to be engaged by the latch portion of the integrated sash lock/tilt latch fastener of FIG. 1A.

FIG. 67 is a second perspective view of the keeper of FIG. 66.

FIG. 68 is a front view of the keeper of FIG. 66.

FIG. 69 is a first end view of the keeper of FIG. 68.

FIG. 70 is a second end view of the keeper of FIG. 68.

FIG. 71 is a rear view of the keeper of FIG. 68.

FIG. 72 is a top view of the keeper of FIG. 68.

FIG. 73 is a bottom view of the keeper of FIG. 68.

FIG. 74 is a perspective view of the engagement spring of the keeper.

FIG. 75 is a bottom perspective view of the keeper of FIG. 66.

FIG. 76 is a first perspective view of the keeper of FIG. 75 and the engagement spring of FIG. 74, after being assembled together.

FIG. 77 is a second perspective view of the keeper and engagement spring assembly of FIG. 76.

FIG. 78 is a front view of the keeper and engagement spring assembly of FIG. 76.

FIG. 79 is a bottom view of the keeper and engagement spring assembly of FIG. 78.

FIG. 80 is a perspective view of the master window frame (or fixed sash member or second sliding sash member) that is configured to releasably receive the keeper and engagement spring assembly of FIG. 76.

FIG. 81 is a top view of the window frame of FIG. 80.

FIG. 82 is an end view of the window frame of FIG. 81.

FIG. 83 is a bottom view of the window frame of FIG. 81.

FIG. 84 is a side view illustrating insertion of the first hooked leg of the keeper and engagement spring assembly of FIG. 76, into a first corresponding opening in the window frame of FIG. 80.

FIG. 85 is the side view of FIG. 85, after insertion of both the first hooked leg and the second leg of the keeper and engagement spring assembly of FIG. 76, into the corresponding openings in the window frame of FIG. 80.

FIG. 86 is the side view of FIG. 85, after sliding of both the first hooked leg and the second hooked leg of the keeper assembly laterally within the corresponding openings in the window frame, and with the engagement spring engaging one of the openings to releasably secure the keeper to the window frame.

FIG. 87 is a perspective view showing the keeper assembly of FIG. 76 releasably installed upon the window frame of FIG. 80.

FIG. 88 is a perspective view of the frame of a sliding sash window configured to receive the integrated sash lock/tilt latch fastener of FIG. 1A.

FIG. 89 is a top view of the sliding sash window frame of FIG. 88.

FIG. 90 is an end view of the sliding sash window frame of FIG. 89.

FIG. 91 is a bottom view of the sliding sash window frame of FIG. 89.

FIG. 92 is a side view illustrating insertion of the first hooked leg of the sash lock assembly of FIG. 39 into a first corresponding opening in the sliding sash window frame of FIG. 88.

FIG. 93 is the side view of FIG. 92, after insertion of each of the first hooked leg, the second leg, and the third leg of the sash lock assembly into the corresponding openings in the sliding sash window frame.

FIG. 94 is the side view of FIG. 93, after sliding of each of the first, second, and third legs of the sash lock assembly laterally within the corresponding openings in the sliding sash window frame, and with the engagement spring engaging one of the openings to releasably secure the sash lock assembly to the sliding sash window frame.

FIG. 94A is a perspective view of the sash lock assembly releasably secured to the sliding sash window frame, as seen in FIG. 94.

FIG. 95 illustrates size adjustment of the latch member with the dual beam and funnel members of FIG. 56 into the latch member of FIG. 60 with a singular beam and funnel members, just prior to insertion into the sliding sash window frame having the sash lock assembly secured thereon, as seen in FIG. 94.

FIG. 96 is the perspective view of the sash lock assembly seen in FIG. 39, but shown reduced in size.

FIG. 97 illustrates the size-adjusted latch assembly just prior to being coupled to the post of the pivotal lever arm of the sash lock assembly.

FIG. 98 illustrates initial contact of the fixed funnel member of the latch assembly, with the post of the pivotal lever arm of the sash lock assembly seen in FIG. 97.

FIG. 99 illustrates movement of the latch tongue towards the retracted position to cause lateral deflection of the beam and fixed funnel member of the latch assembly in a first lateral direction, as a result of sliding contact between the post of the pivotal lever arm of the sash lock assembly with the fixed funnel member. FIG. 99 also illustrates lateral deflection of the flexible funnel member in a second direction, to create a temporary pathway for the post of the pivotal lever arm to be received into an opening in the latch assembly formed by the fixed and flexible funnel members.

FIG. 100 illustrates the post of the pivotal lever arm fully received into the opening in the latch assembly formed by the fixed and flexible funnel members, and with the tongue still in the retracted position.

FIG. 101 illustrates the engagement of the post of the pivotal lever arm in the opening in the latch assembly formed by the fixed and flexible funnel members, but with the tongue having been biased into the extended position, thereby biasing the pivotal lever arm toward the latch locked position.

FIG. 102 is a side cross-sectional view through the sliding sash window frame, with the sash lock assembly installed thereon, and with the latch assembly installed into the frame and engaged with the post of the pivotal lever arm of the sash lock. The integrated sash lock/tilt latch fastener is shown in the locked and latched position.

FIG. 103 is a bottom perspective view of the sash lock assembly of FIG. 102, showing positioning of the cam and the post of the pivotal lever arm when the integrated sash lock/tilt latch fastener is in the locked and latched position.

FIG. 104 is the view of FIG. 102, but with the sash lock handle pivoted so that the integrated sash lock/tilt latch fastener is in the unlocked and unlatched position.

FIG. 105 is a bottom perspective view of the sash lock assembly of FIG. 104, showing positioning of the cam and the post of the pivotal lever arm when the integrated sash lock/tilt latch fastener is in the unlocked and unlatched position.

FIG. 106 is the view of FIG. 104 with the integrated sash lock/tilt latch fastener in the locked and latched position, but shown reduced in size.

FIG. 107 is an end view of the integrated sash lock/tilt latch fastener installed within the sliding sash window frame, as seen in FIG. 106.

FIG. 108 is a perspective of the integrated sash lock/tilt latch fastener installed within the sliding sash window frame, as seen in FIG. 106.

FIG. 109 is a bottom view of the sash lock assembly of FIG. 106, showing positioning of the cam and the post of the pivotal lever arm when the integrated sash lock/tilt latch fastener is in the locked and latched position.

FIG. 110 is the view of FIG. 104, but shown with the handle of the sash lock assembly having been rotated to place the integrated sash lock/tilt latch fastener in the unlocked and latched position.

FIG. 111 is an end view of the integrated sash lock/tilt latch fastener installed within the sliding sash window frame, as seen in FIG. 110.

FIG. 112 is a perspective view of the integrated sash lock/tilt latch fastener installed within the sliding sash window frame, as seen in FIG. 110.

FIG. 113 is a bottom view of the sash lock assembly of FIG. 110, showing positioning of the cam and the post of the pivotal lever arm when the integrated sash lock/tilt latch fastener is in the unlocked and latched position.

FIG. 114 is the view of FIG. 102, with the integrated sash lock/tilt latch fastener in the unlocked and unlatched position, but shown reduced in size.

FIG. 115 is an end view of the integrated sash lock/tilt latch fastener installed within the sliding sash window frame, as seen in FIG. 114.

FIG. 116 is a perspective view of the integrated sash lock/tilt latch fastener installed within the sliding sash window frame, as seen in FIG. 114.

FIG. 117 is a bottom view of the sash lock assembly of FIG. 114, showing positioning of the cam and the post of the pivotal lever arm when the integrated sash lock/tilt latch fastener is in the unlocked and unlatched position.

FIG. 118 is a reverse perspective view of the sash lock assembly releasably secured to the sliding sash window frame, as seen in FIG. 94A, but with a slender pry tool being inserted through the opening in the sash lock housing and against the engagement spring, to effect removal of the sash lock assembly from the window frame.

FIG. 119 is a cross-sectional view through the arrangement of FIG. 118, but showing the slender pry tool deflecting the sash lock engagement spring out from the corresponding opening in the sliding sash window frame.

FIG. 120 is the cross-sectional view of FIG. 119, but showing the sash lock assembly having been slid to cause disengagement of the sash lock housing legs from the top wall of the meeting rail.

FIG. 121 is the cross-sectional view of FIG. 120, but showing the legs of the sash lock housing having been removed from the openings in the top wall of the meeting rail, and with the slender pry tool being used to subsequently pry the latch assembly out from the window frame.

FIG. 122 is a perspective view showing the slender pry tool being used to pry the latch assembly out from the window frame, as seen in FIG. 121.

FIG. 123 is the perspective view of the keeper assembly releasably secured to the master window frame, as seen in FIG. 87, but with a slender pry tool being inserted through the opening in the keeper housing and against the keeper engagement spring.

FIG. 124 is a cross-sectional view through the arrangement of FIG. 123, but showing the slender pry tool deflecting the keeper engagement spring out from the corresponding opening in the master window frame.

FIG. 125 is the cross-sectional view of FIG. 124, but showing the sash lock assembly having been slid to cause disengagement of the legs of the keeper housing from the top wall of the master frame.

FIG. 126 is the cross-sectional view of FIG. 125, but showing the sash lock assembly being pivoted to cause removal of the legs of the keeper housing from the top wall of the master frame.

FIG. 127A is a side perspective view of an alternate embodiment of the latch member shown in FIG. 56.

FIG. 127B is a top perspective view of the latch member shown in FIG. 127A.

FIG. 128A is a perspective view of an alternate embodiment of the latch assembly of FIG. 63, which use the latch member shown in FIG. 127A.

FIG. 128B is a top view of the latch assembly of FIG. 128A.

FIG. 129 is a perspective view showing a series of suitable openings in the meeting rail, for use in mounting the lock assembly of FIG. 39 thereon, in cooperation with the latch assembly of FIG. 127A.

FIG. 130 is a top view of the meeting rail openings shown in FIG. 129.

FIG. 131 is an end view of the meeting rail of FIG. 130.

FIG. 132 is a cross-sectional view through the meeting rail openings of FIG. 130.

FIG. 133 is a perspective view illustrating the latch assembly of FIG. 127A prior to being receiving through an opening in the side of the sash window frame.

FIG. 134 is a perspective view showing the meeting rail of FIG. 129, after receiving the latch assembly of FIG. 127A therein.

FIG. 135 is a top view of the meeting rail with latch assembly, as seen in FIG. 134.

FIG. 136 is an end view of the meeting rail with latch assembly, as seen in FIG. 134.

FIG. 137 is a side view of the meeting rail with latch assembly, as seen in FIG. 134.

FIG. 138 is an enlarged side view of the lock assembly of FIG. 39.

FIG. 139 is an enlarged side view of the lock assembly of FIG. 39.

FIG. 140 is the perspective view of the meeting rail of FIG. 134, shown with the lock assembly at an initial position being just prior to it being coupled thereto.

FIG. 141 shows a side view of the meeting rail and lock assembly of FIG. 140, after the post of the lock assembly has been inserted into the corresponding opening in the top of the meeting rail, and through the opening in the beam of the latch member.

FIG. 141A is a top view of the opening in the beam of the latch member of FIG. 141, with the post of the lever arm received there-through.

FIG. 142 is the side view of FIG. 141, after the lock assembly has been pivoted roughly 90 degrees to orient the legs of the lock assembly housing to be aligned with, but laterally displaced from, the openings in the top of the meeting rail.

FIG. 142A is a top view of the opening in the beam of the latch member of FIG. 142, with the post of the lever arm shown rotated roughly 90 degrees with respect to the opening.

FIG. 143 is the side view of FIG. 142, after the lock assembly has been translated for the legs of the lock assembly housing to be adjacent to the openings in the top of the meeting rail.

FIG. 144 is the side view of FIG. 143, after the legs of the lock assembly housing have been inserted through the openings in the top of the meeting rail.

FIG. 145 is the side view of FIG. 144, after the lock assembly has been slid relative to the meeting rail, for the legs of the lock assembly to engage the openings in the top of the meeting rail.

FIG. 146 is the perspective view of FIG. 134 showing the meeting rail of FIG. 129, after receiving the latch assembly of FIG. 127A therein, and after the lock assembly has also been mounted thereto.

### DETAILED DESCRIPTION OF THE INVENTION

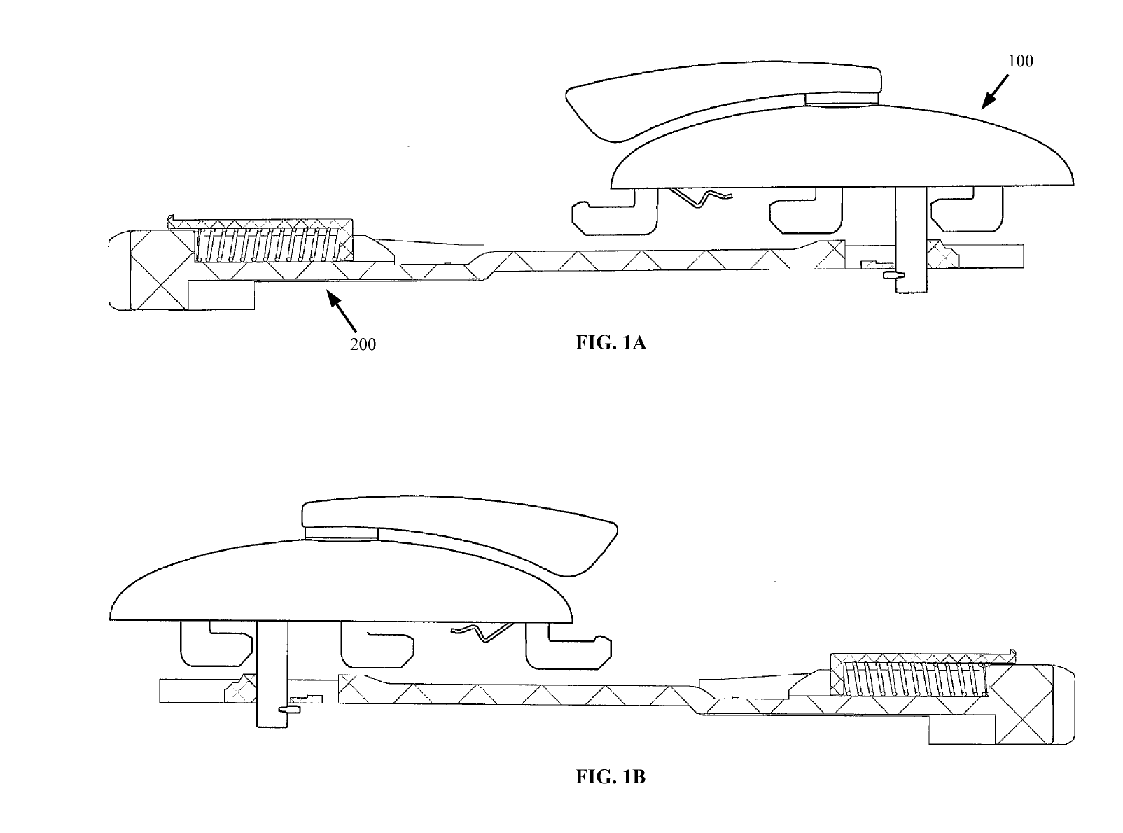

FIGS. 1A and 1B show a first embodiment of the present invention, in the form of a left-hand and a right-hand integrated sash lock/tilt latch fastener, either of which, or both of which may be used in the construction of a sash window. To simplify the presentation herein, since the right-hand version is a mirrored version of the left-hand fastener, being made up of mirror imaged parts, all discussions throughout this disclosure will be directed only to the left-hand fastener shown in FIG. 1A.

The integrated sash lock/tilt latch fastener of FIG. 1A may include a lock assembly 100, and a latch assembly 200, which may be blindly mated to the lock assembly during installation of each into the meeting rail of the sash window, an installation that may furthermore be accomplished without the use of screws or other mechanical fasteners.

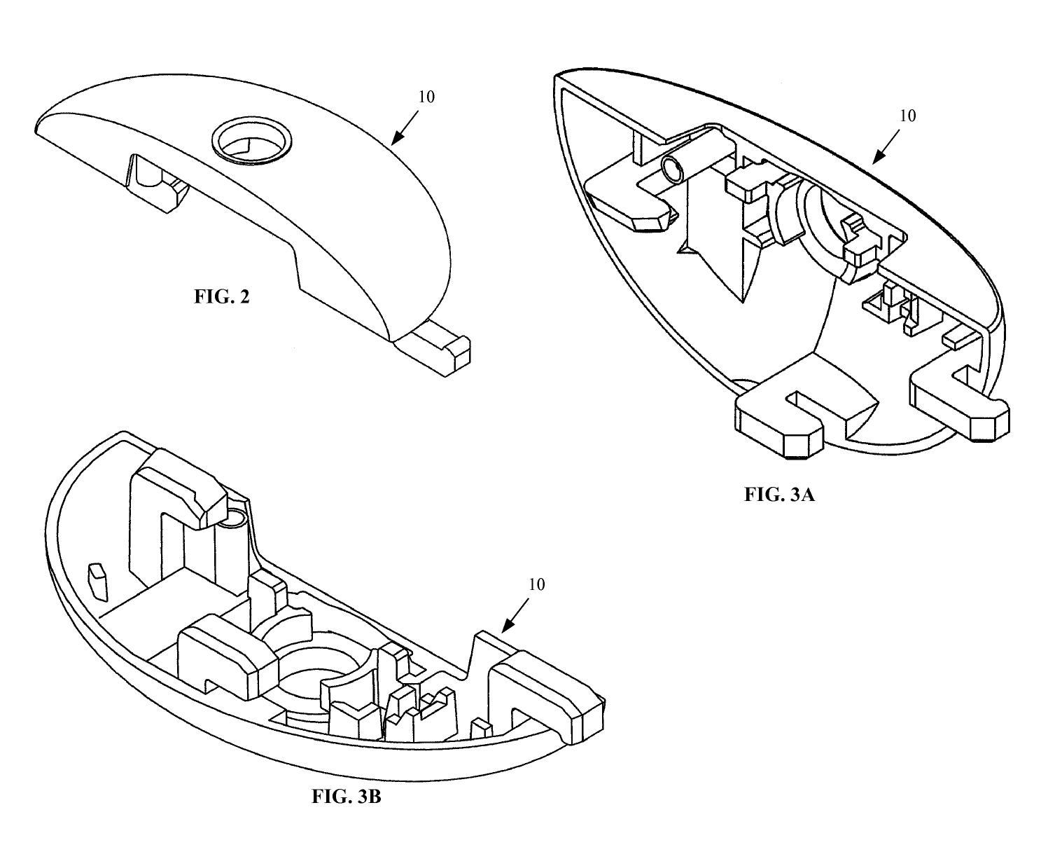

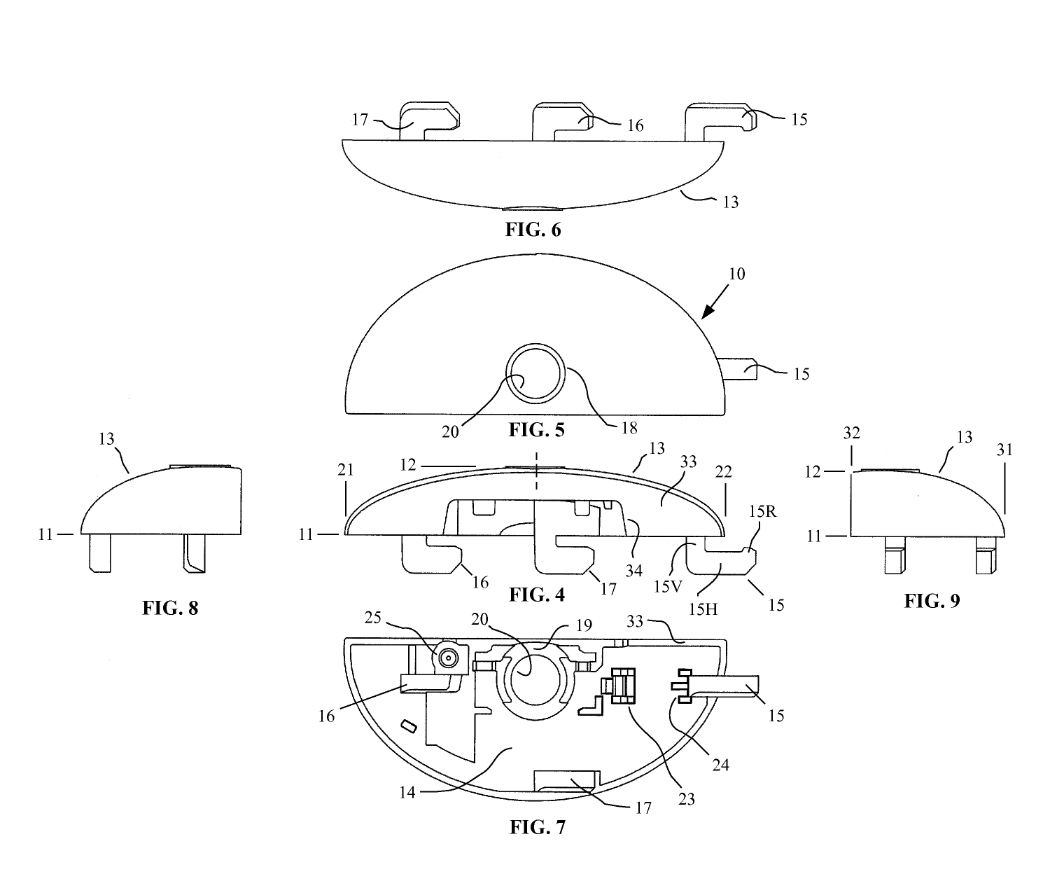

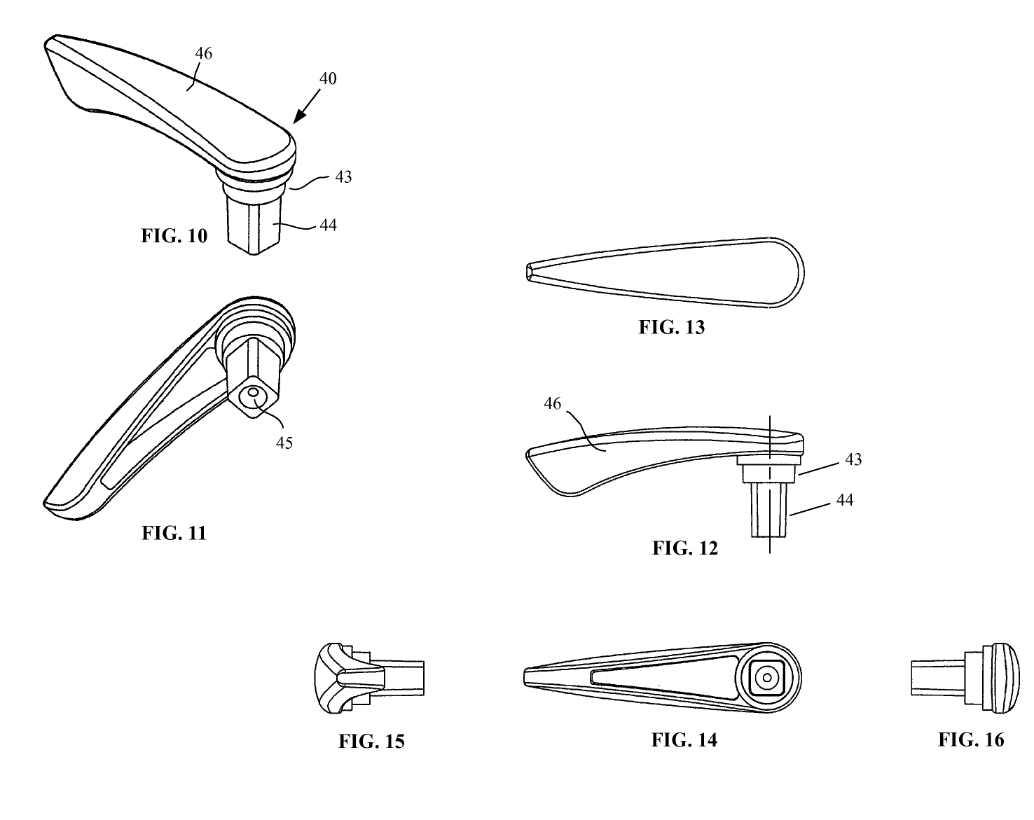

Perspective views of the housing 10 of the sash lock assembly 100 are shown in FIGS. 2, 3A, and 3B, while corresponding orthogonal views are shown in FIGS. 4-9. The housing 10 is not limited to the shape illustrated within FIGS. 4-9, and could take on many different appropriate shapes, including a rectangular shape, an irregular shape, etc. However, the housing 10 may be desirably shaped to have a curved outer surface 13, which may generally appear semi-circular in the top view of FIG. 5, spanning from a first end 21 to second end 22, and may appear to be part elliptical in the end view of FIG. 9. The curvature of surface 13 may terminate at a generally flat bottom surface 11, and may curve upwardly to reach an apex 12 in FIG. 4. The curvature of surface 13 may also transition, as seen in FIG. 9, into a generally flat surface 32, at which a wall 33 may be formed. The housing 10 may be hollowed to form an interior surface 14, and the wall 33 may have an opening 34 into the interior cavity of the housing.

Extending outwardly from the bottom of the housing 10 may be one or more legs that may be used to secure the sash lock assembly 100 to the sash window. In one embodiment of the housing, one leg constructed according to the following description may suffice for releasably securing of the sash lock assembly 100 to the sash window. In the embodiment shown within FIGS. 4-9, three such legs may provide for more stable and secure mating of the sash lock housing 10 to the meeting rail. As seen in FIGS. 4 and 7, first, second, and third legs, 15, 16, and 17, respectively, may each protrude down from the cavity of the housing to extend beyond the extent of flat bottom surface 11. The first and second legs, 15 and 16, may be disposed in closer proximity to wall 33, while the third leg 17 may be disposed to be closer to the center of the semicircular housing base 31. The first leg 15 may be a hook-shaped leg, in that, as seen in FIG. 4, it may not only have a “vertical” portion 15V extending away from the interior surface 14, and a “horizontal” portion 1511 that extends laterally from the end of the vertical portion 15V, but it may also has a return flange 15R that extends from the end of the “horizontal” portion 1511 back towards the interior surface 14. The use of hooked leg 15 and legs 16 and 17 is discussed hereinafter with respect to installation of the sash lock assembly 100.

The housing 10 may have a cylindrical boss 18 extending upwardly from the outer surface 13, and may have a cylindrical boss 19 extending downwardly from the interior surface 14, into the housing cavity. Cylindrical boss 18 and cylindrical boss 19 may be generally coaxial, and may have a through hole 20 positioned therein. The hole 20 may be used for pivotal mounting of a shaft extending from the locking cam, or alternatively, the hole 20 may be used for pivotal mounting of a separate shaft/handle member, to which the locking cam may instead be fixedly secured.

In the embodiment illustrated herein, as seen in FIGS. 10-16, a shaft member 46 may have a cylindrical shaft 43, one end of which may have a keyed protrusion 44 extending therefrom, with an orifice therein. The other end of the shaft 43 may have a graspable handle portion that extends generally orthogonally with respect to the axis of shaft 43. The shaft 43 may be received through the hole 20 in the bosses 18 and 19 of the housing 10. The keyed protrusion 44 may be any suitable cross-sectional shape, and in this example, the keyed protrusion is formed using a rectangular cross-section.

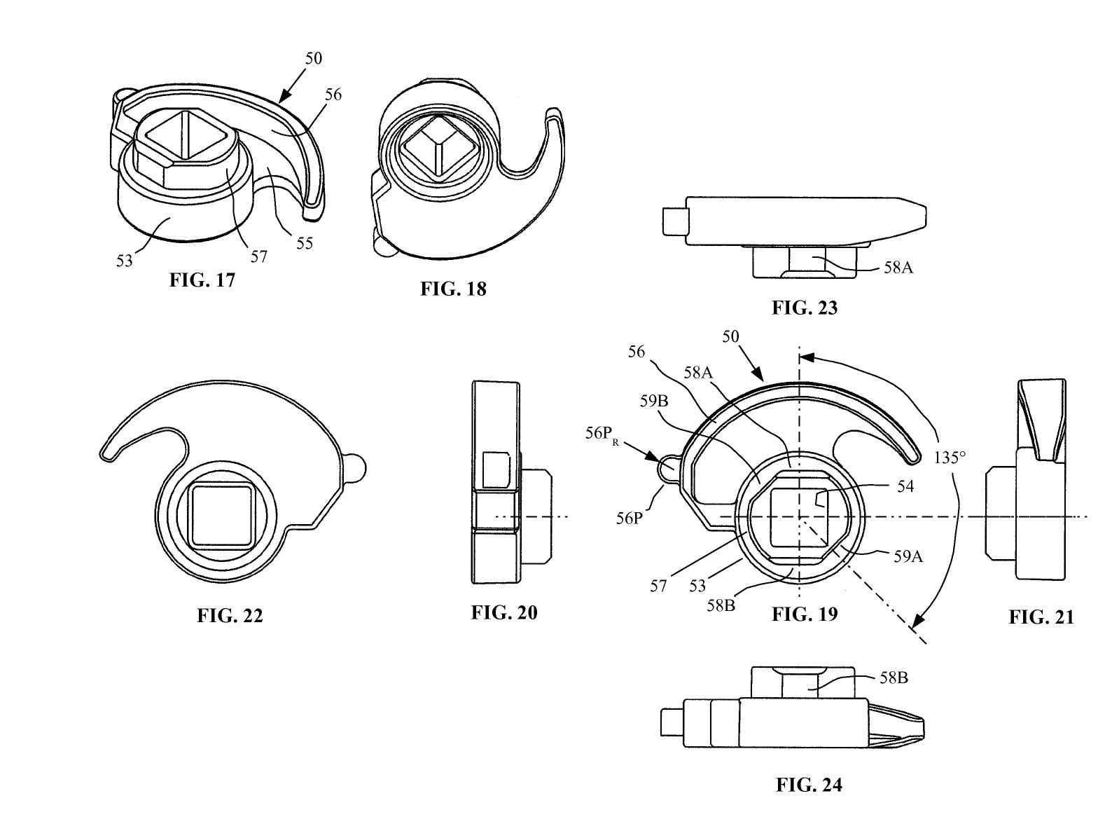

The locking cam 50 illustrated in FIGS. 17-24 may have a cylindrical hub 53, with a keyed opening 54 that is shaped to match the keyed protrusion 44 of the shaft member 46. Extending laterally away from the hub 53 may be a wall 55, and extending away from both the hub 53 and the flat wall 55 may be a curved cam wall 56, that may be used to engage the key of the corresponding keeper, and to draw the sliding sash window in closer proximity to the master window frame (or other sash window for a double-hung arrangement). The curved cam wall 56 may have a curved protrusion 56P protruding laterally therefrom, which may be a semi-cylindrically shaped protrusion. The axis of the radial surface 56P_{R} of the semi-cylindrical protrusion 56P may be substantially parallel to the axis of the keyed protrusion 44 of the shaft member 46.

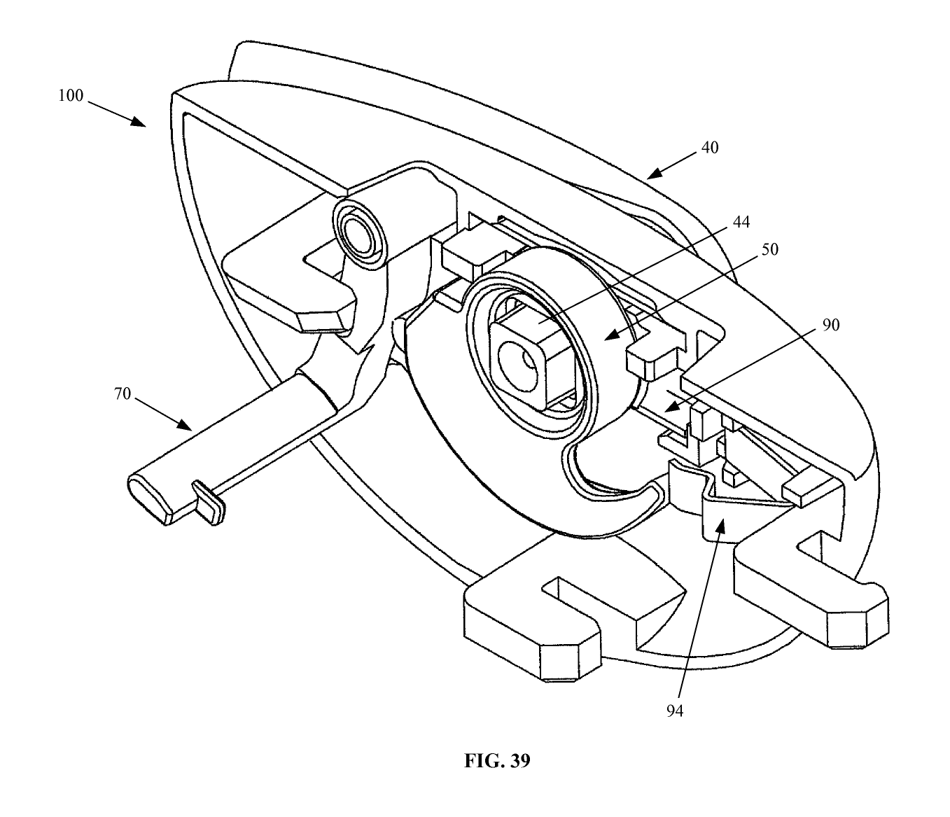

Protruding away from the hub 53 may be a cylindrical member 57, which may be generally concentric with the hub. The cylindrical member 57 may have a first flat 58A formed thereon, and a second flat 58B formed thereon to be clocked 180 degrees away from the first flat 58A. The flats 58A and 58B may operate as a detent to releasably secure the cam 50, at a sash locked position and at a sash unlocked position, with respect to the leaf spring 80 shown in FIG. 38, discussed hereinafter. A third flat 59A may also be formed in the cylindrical member 57, as seen in FIG. 19, at a position that is clocked roughly 135 degrees from the first flat 58A. The flat 59A may also operate as a detent to releasably secure the cam 50 with respect to the leaf spring 80, at another sash unlocked position, which will be termed herein, with respect to the operation of the sash lock discussed hereinafter, as a first sash unlocked position. The sash unlocked position arising from the flat 58B will be referred to herein as the second sash unlocked position. For symmetry and greater stability of the cam being releasably retained at the first sash unlocked position, a fourth flat 59B may be positioned on the cylindrical member 57 at a position that is clocked roughly 180 degrees from the third flat 59A, and may releasably engage a second leaf spring. Note that the flats could be formed on the cylindrical hub 53, instead of on the protruding cylindrical member 57.

Assembly of the locking cam 50 and the shaft/handle member 46 into housing 10 may be seen in FIGS. 39-41. Prior to such assembly, the leaf spring 90, shown in FIG. 38, which may be a generally flat elongated flexible member, may be installed into the housing interior. The ends of leaf spring 90 may be fixedly received within a pair of corresponding recesses in the housing, using a friction fit, or adhesive, or mechanical fasteners, etc. As mentioned above, a second leaf spring 90′ may be used, and may similarly be secured within the housing cavity, to be at a distance away from the first leaf spring that is roughly the same as the distance between the pair of flats 58A and 58B, which may be roughly the same as the distance between the pair of flats 59A and 59B. The cylindrical shaft 43 of the shaft/handle member 46 may then be pivotally received in hole 20 of housing 10, and the keyed protrusion 44 of the shaft member 46 may be received upon the keyed opening 54 of locking cam 50, and may be secured thereat using a friction fit, adhesive, mechanical fasteners, or by being welded thereto, of by using any combination of such suitable means of securing two parts together.

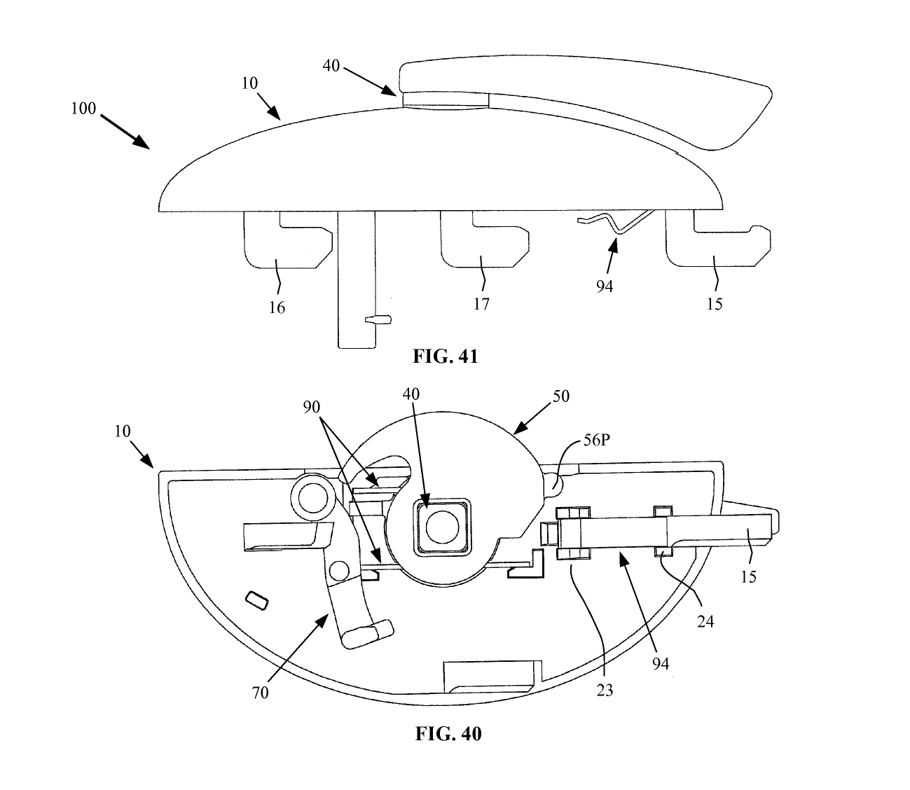

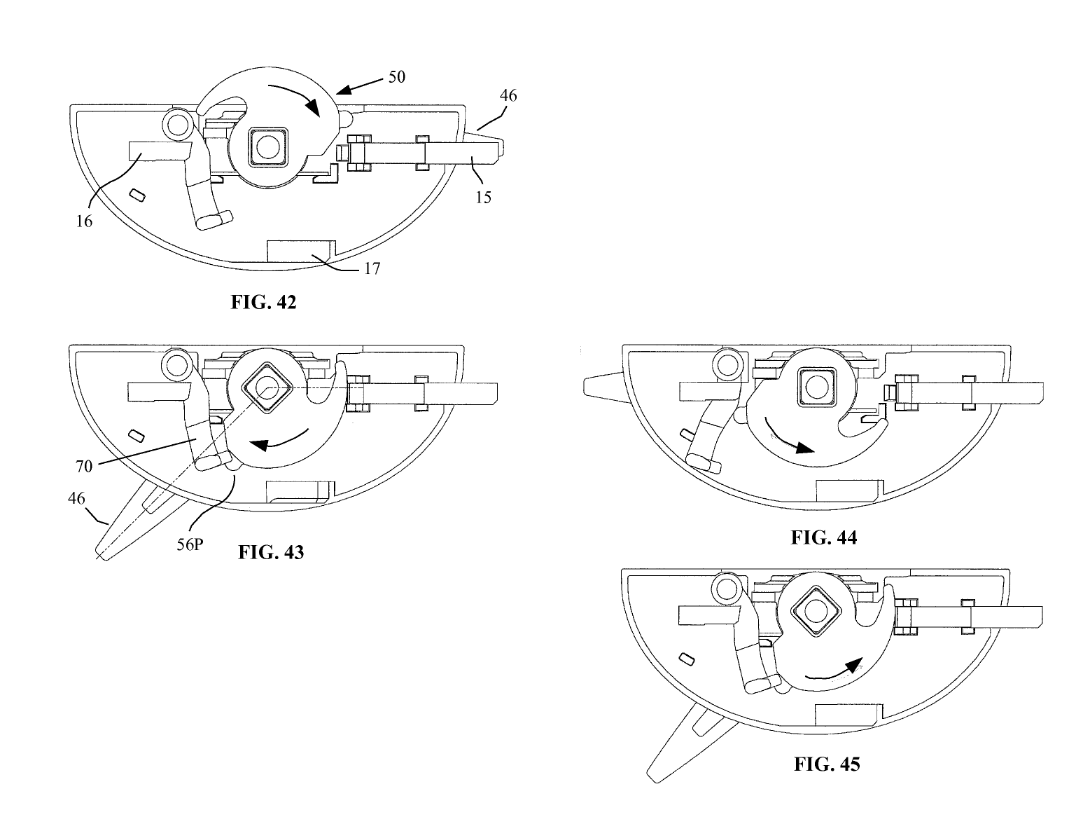

To accommodate screwless installation of the sash lock assembly 100 upon the meeting rail of the sliding sash window, an engagement spring 94 may be utilized in addition to the use of the first, second, and third legs (15, 16, and 17) of the sash lock housing. Engagement spring 94, as seen detailed in FIGS. 34-37, may have a first flange 95 and a second flange 96 that are flexibly connected with a bend 96B therebetween. The first flexible flange 95 may have a mounting flange 97 extending therefrom. The second flexible flange 96 may have a double-legged bend formed thereon to be distal from bend 96B, and may be formed by leg 98 being at an angle with respect to flange 96, and by a second leg 99 being at an angle with respect to the first leg 98. The legs 98 and 99 may create a V-shaped notch that may be used for installation of the sash lock assembly 100 upon the meeting rail of the sliding sash window, as discussed hereinafter. The engagement spring 94 may be installed into the housing 10, as seen in FIGS. 40-41, with the mounting flange 97 of the spring being fixedly received within a recess in a protrusion 23 (FIG. 7) that protrudes out from the interior surface 14 of housing. The end of flange 95 of the engagement spring 94 that is proximate to bend 96B may be supported by another protrusion 24 that protrudes out from the interior surface 14 of housing.

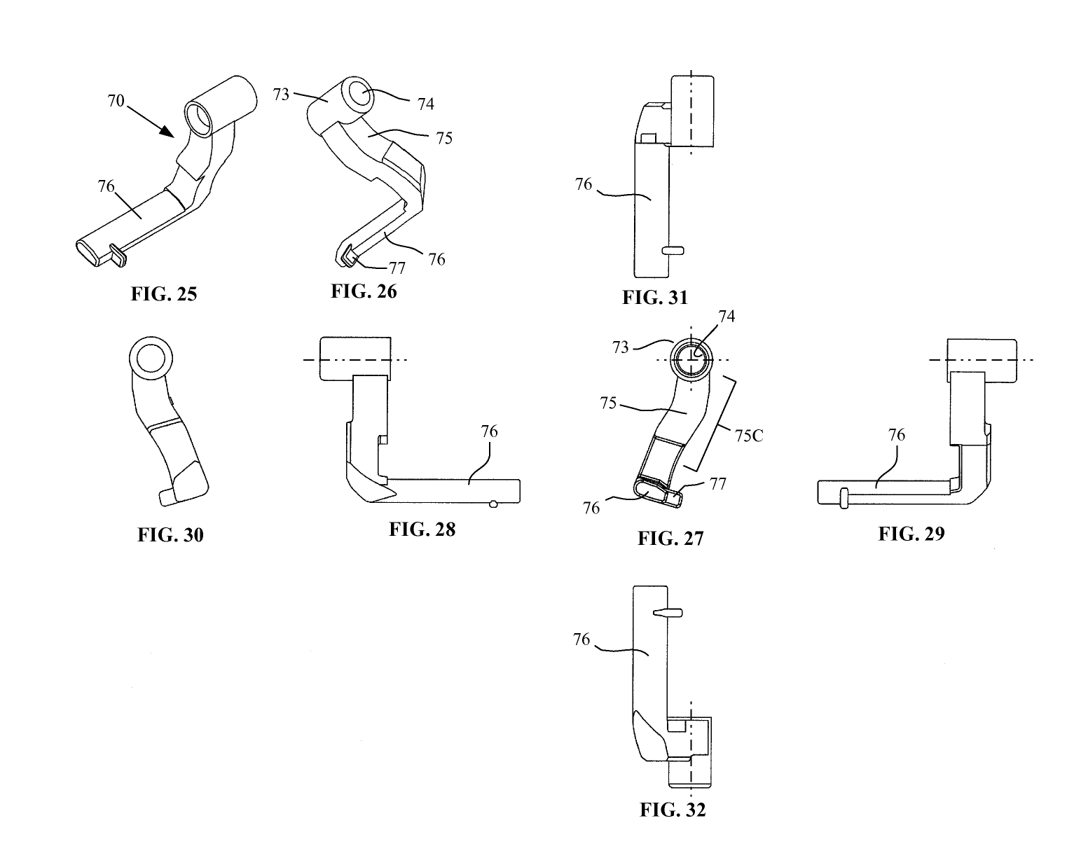

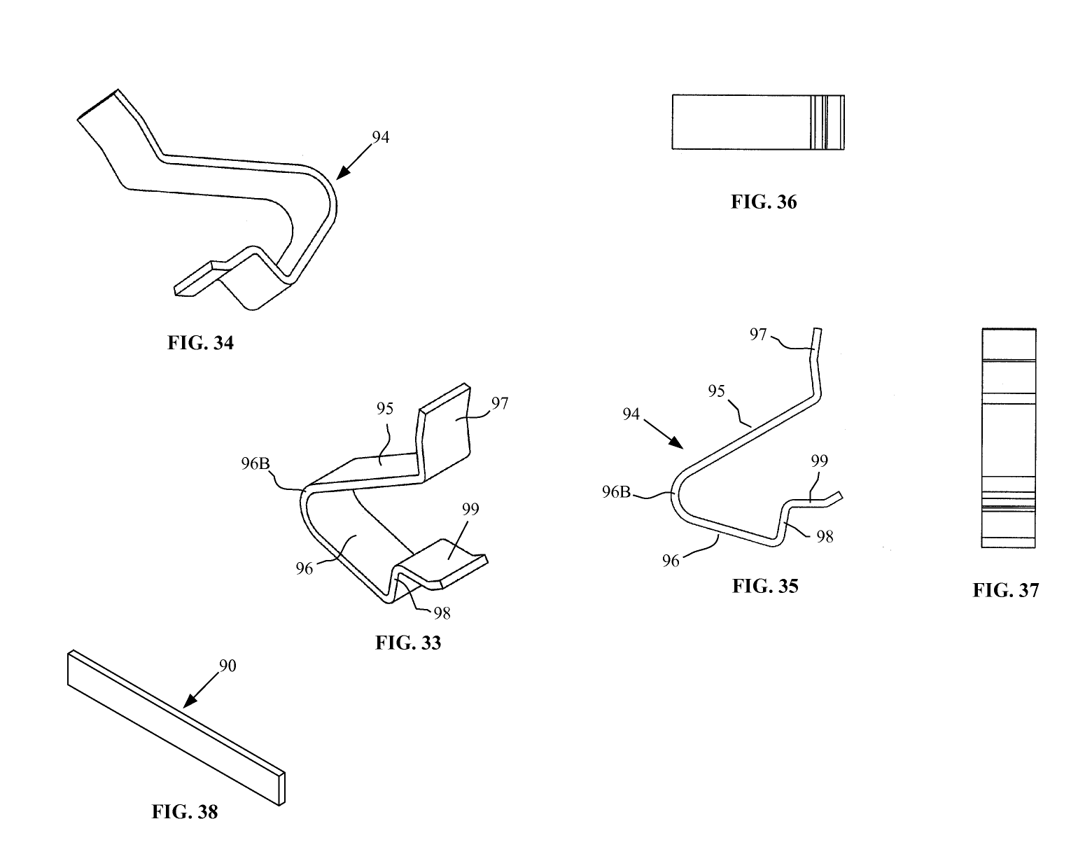

Interaction between the sash lock assembly 100, once installed upon the meeting rail of the sliding sash window, with the latch assembly 200, may be through the use of a lever arm 70 that may be pivotally mounted to the housing 10. The lever arm 70 is seen detailed within FIGS. 25-32. Lever arm 70 may include a hub 73, with a generally concentric mounting hole 74 therein. Extending laterally away from the axis of the hub 73 may be an arm 75, which may have a curved surface 75C that is selectively shaped to be driven by the semi-cylindrical protrusion 56P of the locking cam 50, as discussed hereinafter. The arm 75 may transition into a post 76 that may be generally orthogonal to the arm 76 and may be generally parallel to the axis of the hub 73. A stop 77 may protrude from the post 76. The housing 10, as seen in FIG. 7, may have a shaft 25 that protrudes out from the interior surface 14 of the housing. The mounting hole 74 of the hub 73 of the lever arm 70 may be pivotally received upon the shaft 25 of the housing. To pivotally secure the lever arm 70 thereto, the end of the shaft 25 may be bucked like a rivet, to form a manufactured head to prevent the lever arm from slipping off of the post. Alternatively, a screw or other mechanical fastener may be used for pivotally securing the hub 73 of the lever arm 70 to the housing 10.

The positions that the component parts of the sash lock assembly are capable of occupying is seen in FIGS. 42-45. In FIG. 42, the sash lock is shown in the locked position, with the locking cam being in the extended position where it would engage the key of a keeper to secure the sliding sash window from sliding within the track of the master window frame. Although it may not be seen therein, but may nonetheless be understood from viewing FIGS. 19 and 40, the flat 58A and flat 58B of the cylindrical member 57 on the hub 53 of locking cam 50 may respectively contact and be flush with the leaf springs 90 and 90′. This contact may serve to releasably restrain the locking cam 50 from rotating out of the locked position, without being deliberately moved therefrom.

When the user wishes to unlock the sliding sash window to permit it to slide in the master window frame, the shaft/handle 40 may be rotated, to correspondingly rotate the locking cam, as shown by the arrow in FIG. 42, until reaching the first sash unlocked position (FIG. 43). The locking cam no longer protrudes out from the housing 10 to engage the keeper. Although it may not be seen therein, but may nonetheless be understood from viewing FIGS. 19 and 40, the flat 59A and flat 59B of the cylindrical member 57 on the hub 53 of locking cam 50 may now respectively contact and be flush with the flexible leaf springs 90 and 90′ at this first unlocked position of the locking cam 50. (Note, to increase flexibility of the leaf springs 90 and 90′, only one end of each spring may be fixedly mounted in the housing, or alternatively, both ends may be slidably mounted therein, to easily permit lateral deflection of the leaf springs, but without permitting them to become loosened or disconnected from proper positioning within the housing adjacent to the locking cam).

This contact may serve to releasably restrain the locking cam 50 from rotating out of the first unlocked position, without being deliberately moved therefrom. Note that since the angle at which the flats 58A/58B were clocked from the flats 59A/59B was approximately 135 degrees, the shaft/handle 40 will need to rotate approximately 135 degrees to actuate the sash lock assembly 100 from the locked position in FIG. 41 to the first unlocked position in FIG. 43. This is shown by the movement of the handle portion 46 of the shaft/handle 40 in both figures. It should also be noted that angular displacements other than 135 degrees are also possible, as long as the rotational movement is sufficient to move the locking cam far enough away from the keeper to permit sliding movement of the sash window, and although it may be desirable, the cam need not even be fully retracted within the housing 10.

When the user wishes to unlatch the sliding sash window to permit one end of it to pivot out from the master window frame and into the room for cleaning of the glazing, the she/handle 40 may be rotated to correspondingly rotate the locking cam, as shown by the arrow in FIG. 43, until reaching the second sash unlocked position (FIG. 44), which is also the unlatched position. At the second unlatched position, the locking cam is even further retracted into the housing 10. Although it may not be seen therein, but may nonetheless be understood from viewing FIGS. 19 and 40, the flat 58A and flat 58B of the cylindrical member 57 on the hub 53 of locking cam 50 may again contact and be flush with the leaf springs, but having now been rotated roughly 180 degrees, they may now respectively contact leaf springs 90′ and 90 at this second unlocked position of the locking cam 50.

This contact may serve to releasably restrain the locking cam 50 from rotating out of the second unlocked position, without being deliberately moved therefrom. During this rotation of the locking cam 50 from the first unlocked position to the second unlocked position, being roughly 55 degrees, the semi-cylindrical protrusion 56P of the locking cam 50 contacts the arm 75 of locking the cam, and the continued contact of the protrusion along the curved surface 75C of the arm 75 during the 55 degrees of rotation drives the lever arm 70 to pivot, and to cause unlatching of the latch assembly, as discussed hereinafter.

When the user has pivoted the sash window back into the master window frame, and seeks to latch the window therein, the shaft/handle 40 may be counter-rotated roughly 55 degrees to correspondingly counter-rotate the locking cam, as shown by the arrow in FIG. 44, until reaching the first sash unlocked position (FIG. 45). Thereafter, when the user has slid the window closed, and seeks to lock the lock assembly 100, he/she may further counter-rotate the shaft/handle 40 another 135 degrees to correspondingly counter-rotate the locking cam 50, as shown by the arrow in FIG. 45, until reaching the sash locked position (FIG. 42).

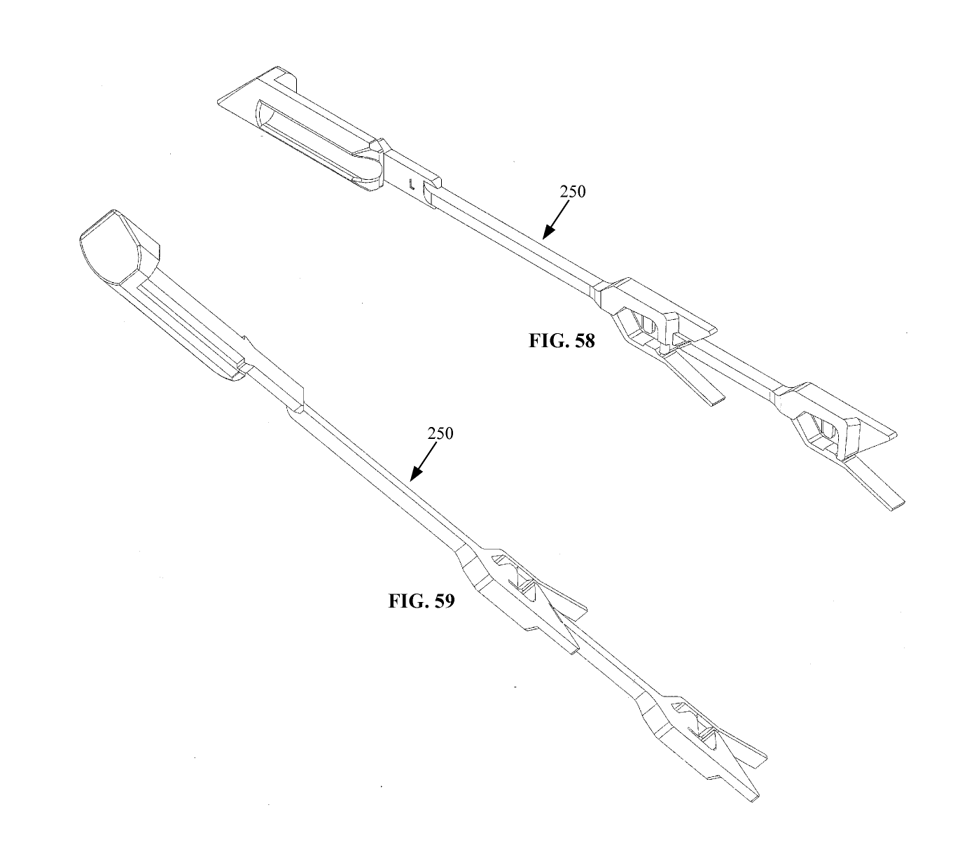

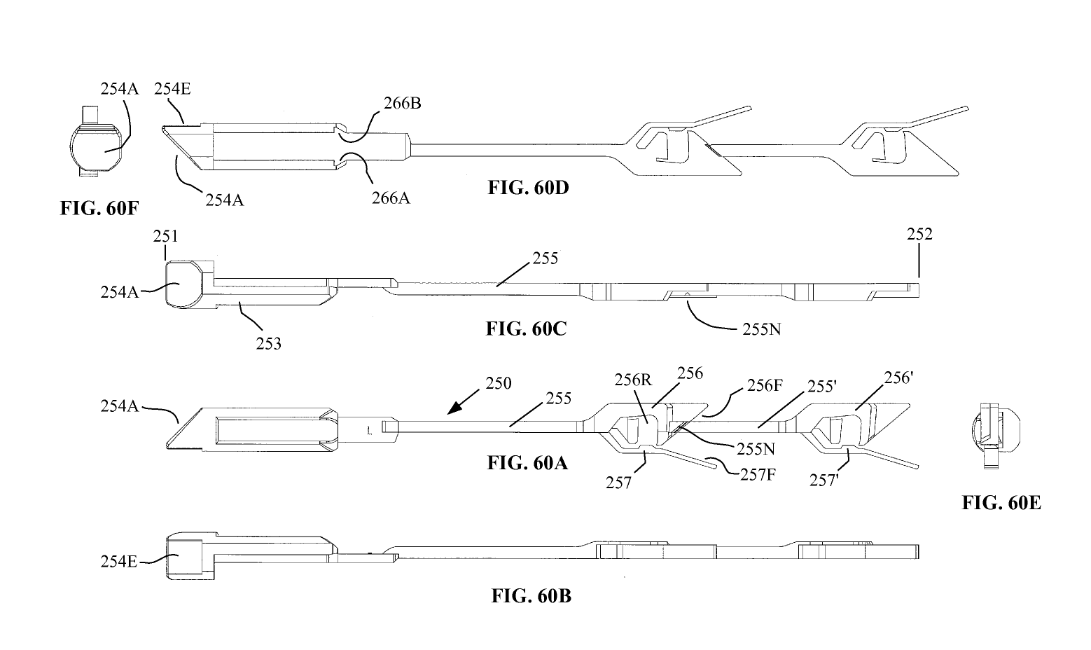

The latch assembly may include a latch member 250 and a biasing means 260. Perspective views of the latch member 250 are shown in FIGS. 56-59, while corresponding orthogonal views are shown in FIGS. 60A-60F. The latch member 250 may extend from first end 251 to second end 252, and may include a tongue 253 that begins at the first end of the latch member and extends only part way to its second end. The tongue 253 may have a generally flat engagement surface 254E that may engage the track of the master window frame to prevent outward tilting of the sliding sash window, and it may also have an angled surface 254A that tapers toward the engagement surface 254E to create an apex. The angled surface 254A may be used, upon contact with the master window frame, to oppose the biasing of the latch member and temporarily drive it into a retracted position, until the tongue enters the track of the master window frame, and is biased into its extended position to have the engagement surface 254E re-engage the track. The tongue 253 may also have one stop 266A protruding therefrom (FIG. 63) or a pair of stops (266A and 266B).

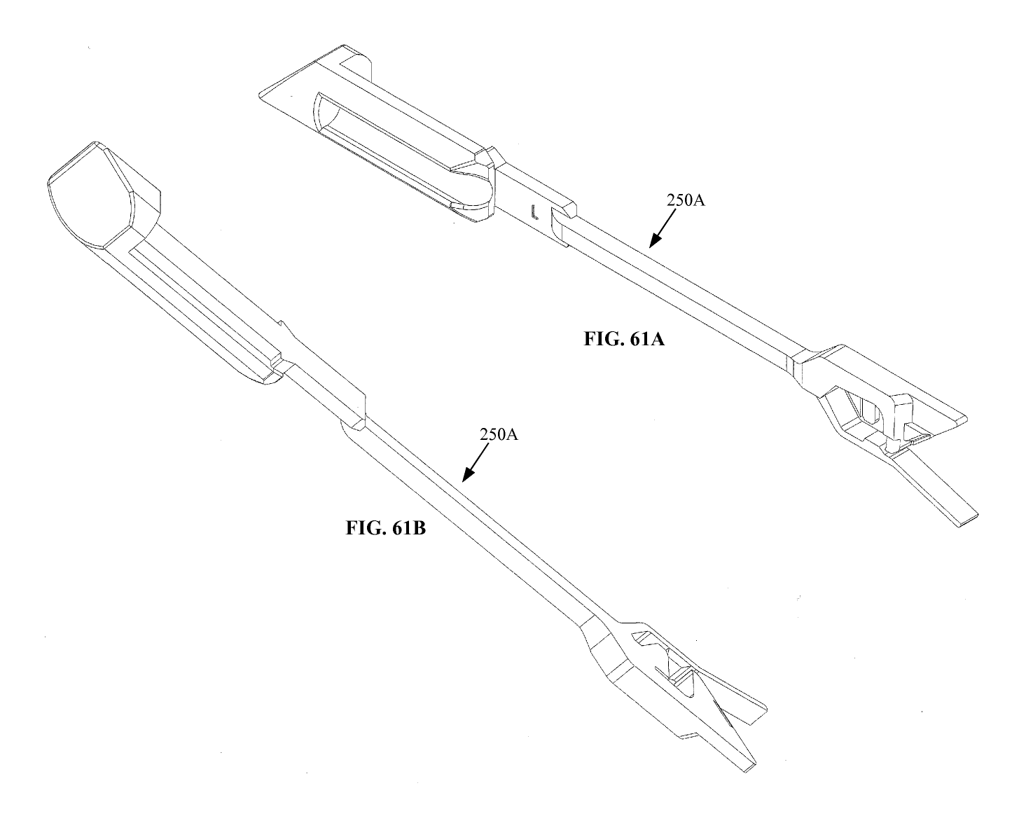

Extending away from the tongue 253 may be an elongated beam 255 that is flexible, and which may terminate in a fixed funnel member 256 and a flexible funnel member 257. The periphery of the fixed funnel member 256 that is distal to its connection with the beam 255 may be shaped to form an angled funnel surface 256F, which may thereafter transition to form a curved recess 256R. The flexible funnel member may be formed with a periphery that, while the flexible funnel member is undeflected, will be generally disposed across the curved recess 256R of the fixed funnel member 256. The periphery of the flexible funnel member 257 that is distal to its connection with the beam 255 may also be shaped to form an angled funnel extension 257F, whereby the angled funnel surface 256F of the fixed funnel member 256, and the angled funnel surface 257F of the flexible funnel member form a V-shaped funnel arrangement, as seen in FIG. 60A. Although this formation of the latch member (see, e.g., FIG. 61) would be sufficient to enable its installation into the sliding sash window, and its co-action therein with the appropriately installed sash lock assembly 100, the latch member 250 shown in. FIG. 60A may additionally include a secondary beam 255′ that extends from the fixed funnel member 256 to be substantially in-line with the primary beam 255, and which also correspondingly has thereon a secondary fixed funnel member 256′ and a secondary flexible funnel member 257′. This arrangement for latch member 250 may permit its use on two different window sizes.

For example, where the sash lock assembly 100 may desirably be located a greater distance away from the master window frame, in a somewhat larger sized window, the secondary fixed/flexible funnel members 256′ and 257′ may be utilized. However, the same latch member 250 may also be utilized where the sash lock assembly 100 may desirably be located at a position closer to the master window frame, in a somewhat smaller sized window, because the secondary beam 255′ with its corresponding secondary fixed/flexible funnel member (256′ and 257′) may be severed from the primary fixed funnel member 256. Its ease of removal and severing therefrom may be accommodated by a notch 255N in the secondary beam 255′ proximate to the first fixed funnel member, to permit a length modification. The notch may be recessed below the angled funnel surface 256F of the fixed funnel member 256 so that its removal would not affect proper operation of the funnel surface, which is discussed further hereinafter. FIGS. 61A and 61B shows the single latch member 250A with only its primary beam/funnel members, which may be originally formed as such, or may alternatively be formed by altering the dual beam/funnel members of latch member 250 through removal of the secondary members (255′, 256′, and 257′).

The dual latch member 250 or the single latch member 250A may be installed through a suitable opening in the side of the meeting rail of the sliding sash window, and may be properly biased using a spring or other biasing means that may be installed therein as well. However, because of the increased complexity of the manufacturing operations necessary to produce the suitable opening in the meeting rail of the sliding sash window, it may be preferable to instead utilize a separate housing with the latch member. The latch housing member 210 may have a simple exterior surface, the complement of which can be easily formed (e.g., bored) into the rail of the sliding sash window, and permit ease of its installation therein.

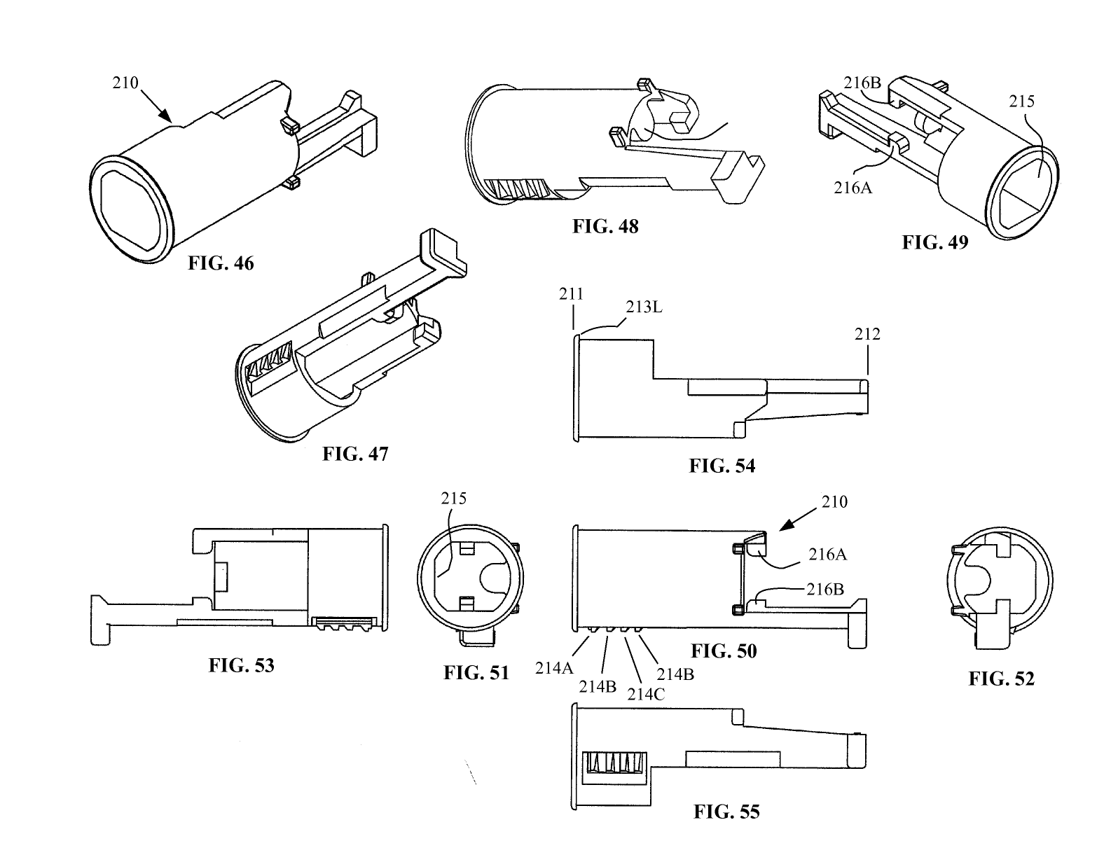

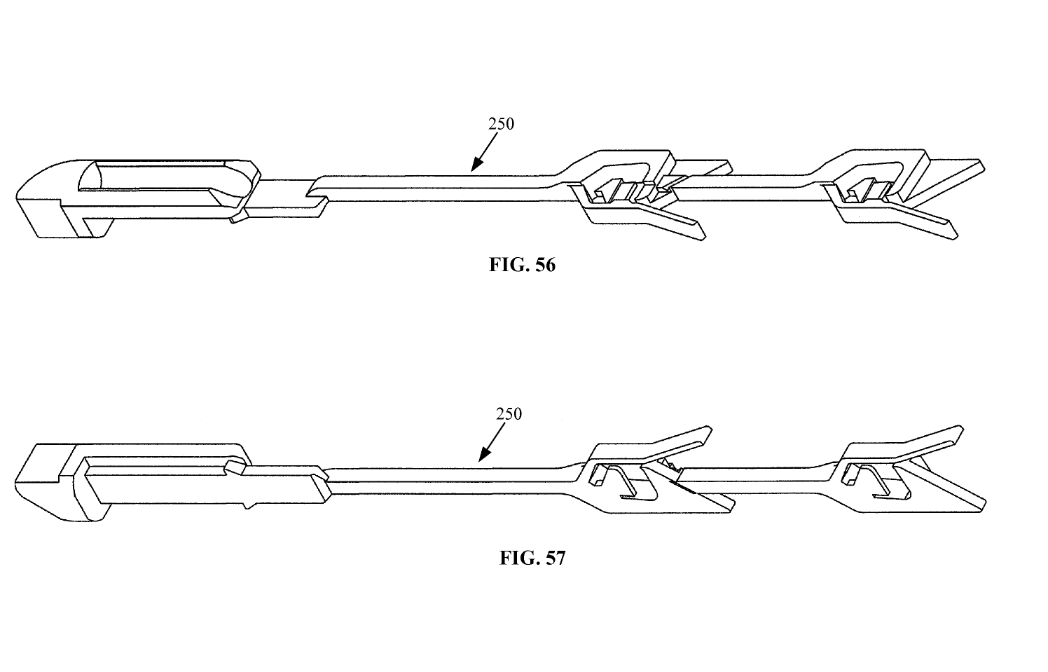

Perspective views of the housing 210 of the latch assembly 200 are shown in FIGS. 46-49, while corresponding orthogonal views are shown in FIGS. 50-55. The housing 210 is not limited to the shape illustrated within FIGS. 50-55, and could take on many different appropriate shapes, including an elongated rectangular shape. However, the housing 210 may be desirably shaped to have a cylindrical outer surface 213, which may span from a first end 211 to second end 212. At the first end 211 of the housing 210, the cylindrical outer surface 213 may be formed into a protruding lip 213L. A portion of the cylindrical outer surface 213 may also have a series of successive teeth (214A, 214B, 214C, 214D,) be formed thereon, for releasable securing of the housing within the hole that is bored/formed in the window rail. The housing 210 may be hollowed out to form an interior surface 215. Protruding upward from the interior surface 215 may be one stop 216A or a pair of stops (216A and 216B). A shaped wall 218 may protrude down to obstruct a portion of the hollowed out interior between the first end 211 and the second end 212.

The biasing of the latch member 250 relative to the housing 210 may be through the use of a suitably arranged tension spring, or by using a compression spring. For the sake of brevity, the figures herein only depict the embodiment where a compression spring is utilized.

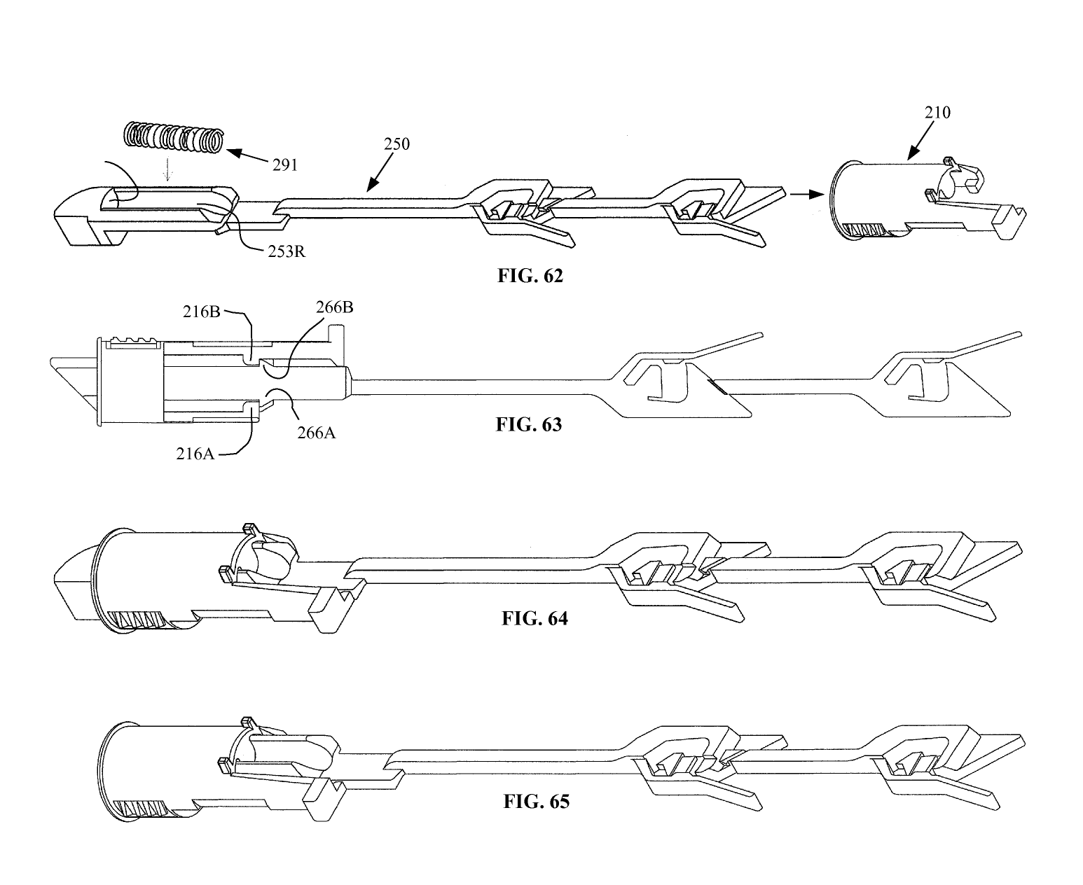

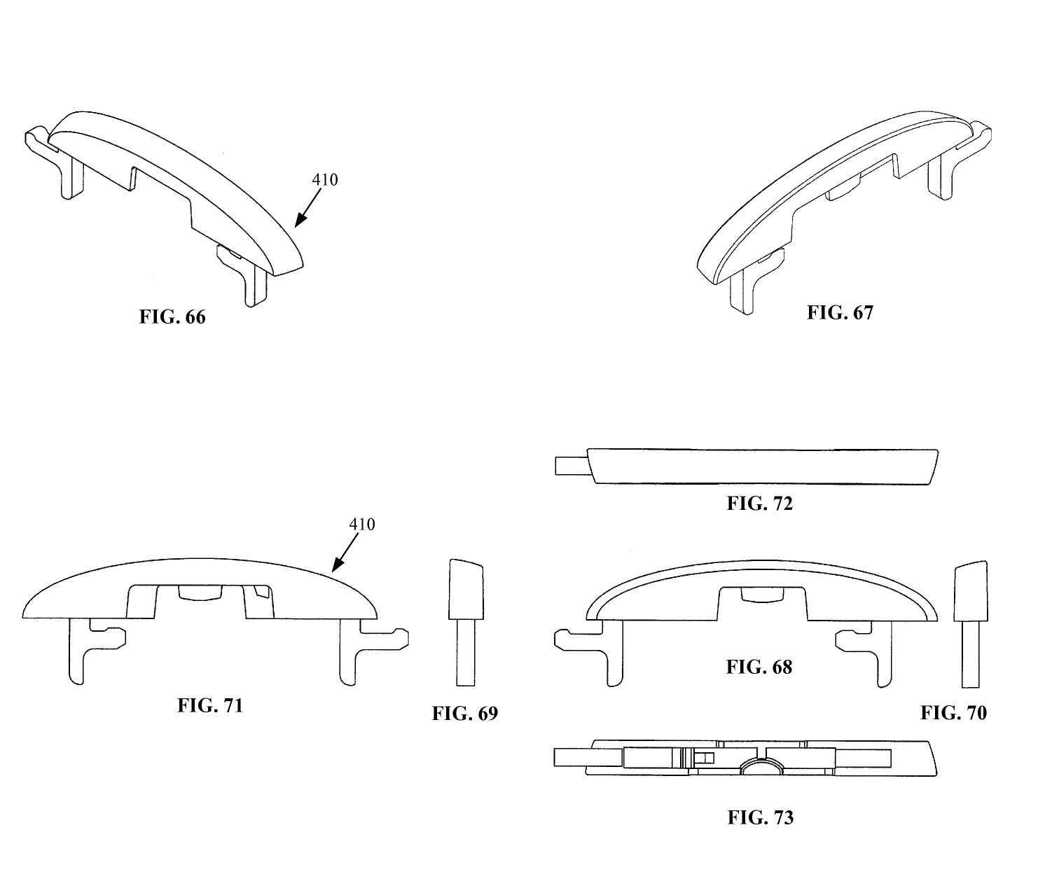

The interior surface 215 of housing 210 may be contoured to receive the latch member 250 therein, in a slidable relation. Assembly of the helical compression spring 291 and the latch member 250 into the housing 210 is illustrated in FIG. 62. The helical spring 291 may be nested in a recess 253R of the tongue 253. One end of the spring may act upon the wall 253W of the tongue 253 (FIG. 62), while the other end of the compression spring may act upon the wall 218 of the housing 210 (FIG. 48), to bias a portion of the tongue, including its apex, to protrude out from the latch housing, as seen in FIG. 63. The extent that biasing by spring 291 may cause the tongue 253 to protrude out from the housing 210 may be limited by the stops 266A and 266B on the tongue contacting the stops 216A and 216B on the housing (FIG. 63). Actuation of the latch member 250 relative to the housing 210 may cause the apex of the tongue to retract within the hollow of the housing, as seen in FIG. 65.

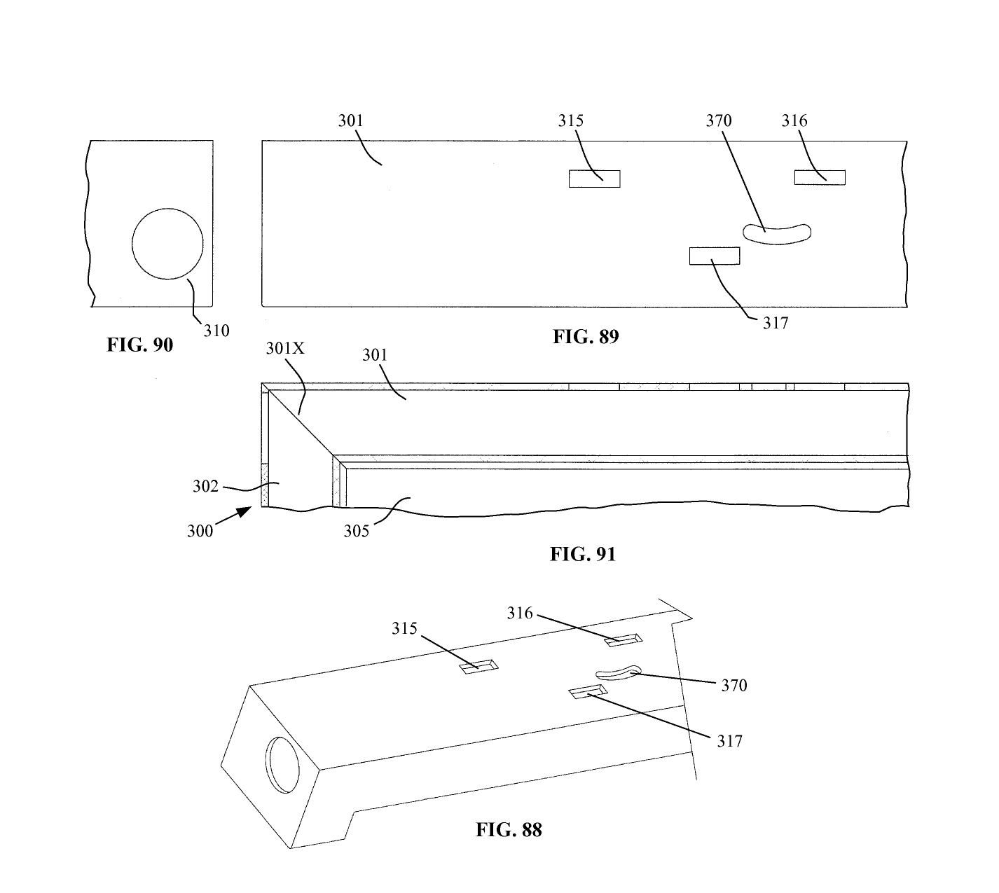

Installation of the sash lock assembly 100 upon the sliding sash window 300 is illustrated within FIGS. 88-94. Sliding sash window 300 may have a horizontal meeting rail 301, a first vertical stile 302, a second stile (not shown) and a bottom rail (not shown), which may form a frame to support the glazing 305 therein. The meeting rail 301 and the stile 302 may each be generally hollow members. For the particular window shown in FIG. 89, the meeting rail 301 is shown to have a transition 301X at a 45 degree angle with the stile 302. Therefore, for the sash window illustrated in FIGS. 88-90, it may be accurate to state that the opening 310 may be formed in the vertical stile 302, rather than in the horizontal rail 301. However, it should be understood that the horizontal meeting rail could instead be configured to extent to the extreme side of the sash window, and that the vertical stile could abut the bottom of the meeting rail, in which case the opening 310 may be described as being in the meeting rail. Throughout this disclosure, the latch assembly is described as being installed in the stile, but that should be understood to mean that it could be either through an opening in the side of the vertical stile or through an opening in the end of the horizontal rail, depending upon how that joint is constructed.

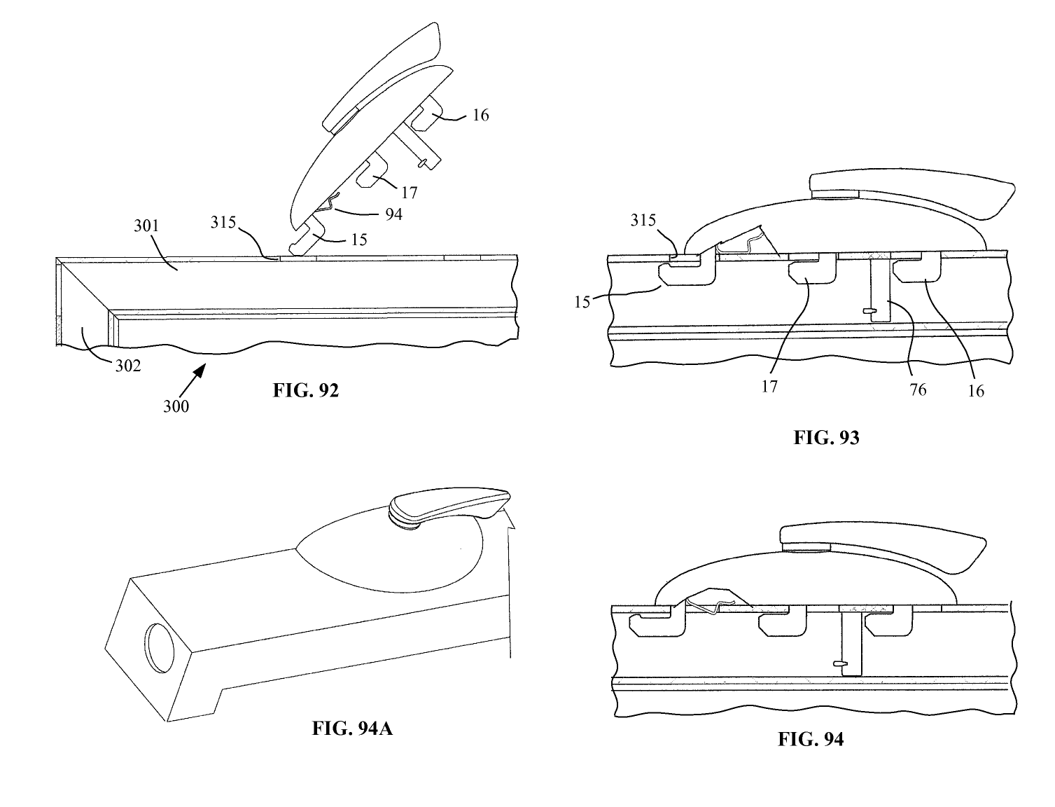

As seen in FIG. 89, a first opening 315, a second opening 316, a third opening 317, and a fourth opening 370 may be formed in the top wall of the meeting rail 301. Openings 315, 316, and 317 may be shaped and positioned to suitably correspond to the footprint of legs 15, 16, and 17 of the housing 10 (FIG. 7). In FIGS. 92 and 93, it may be seen that the hooked leg 15 of housing 10 of the sash assembly 100 may be inserted at an angle, so that the hook of the leg enters the opening and may be inserted beyond the extent of the periphery of the opening 315 in the rail, after which the sash lock assembly may be pivoted about the hook of leg 315, so that legs 16 and 17 are each also respectively inserted through the rail openings 316 and 317. As seen in FIG. 93, the opening 315 may be slightly smaller in the length direction than the footprint of housing leg 15, while the length of the openings 316 and 317 may be slightly larger than corresponding footprints of legs 16 and 17. The width for each of the openings 315, 316, and 317 in the rail may all be slightly larger to afford a clearance fit with the width of legs 15, 16, and 17.

During pivoting of the sash lock assembly 100 for insertion of the legs 16 and 17 into rail openings 316 and 317, the post 77 of the lever arm 70 may also be inserted into rail opening 370, which may be arcuate in shape to accommodate the pivotal motion of the lever arm upon the post 25 of the sash lock housing 10.

Also, during pivoting of the sash lock assembly 100 for insertion of the legs 16 and 17 into openings 316 and 317, the engagement spring 94 may become deflected from its static position with respect to the sash lock housing 10, as seen in FIG. 92, as its flange 96 may now be in contact with the top wall of the stile 301 (FIG. 93).

The final step in installing the sash lock assembly 100 upon the rail of the sliding sash window 300 is to slide the lock assembly laterally, so that the engagement spring 94 may begin to move into the rail opening 315, back towards its undeflected position, until the legs 98 and 99 of the engagement spring 94 may engage the edge of the rail opening 315 that is distal from the stile 302, as seen in FIG. 94.

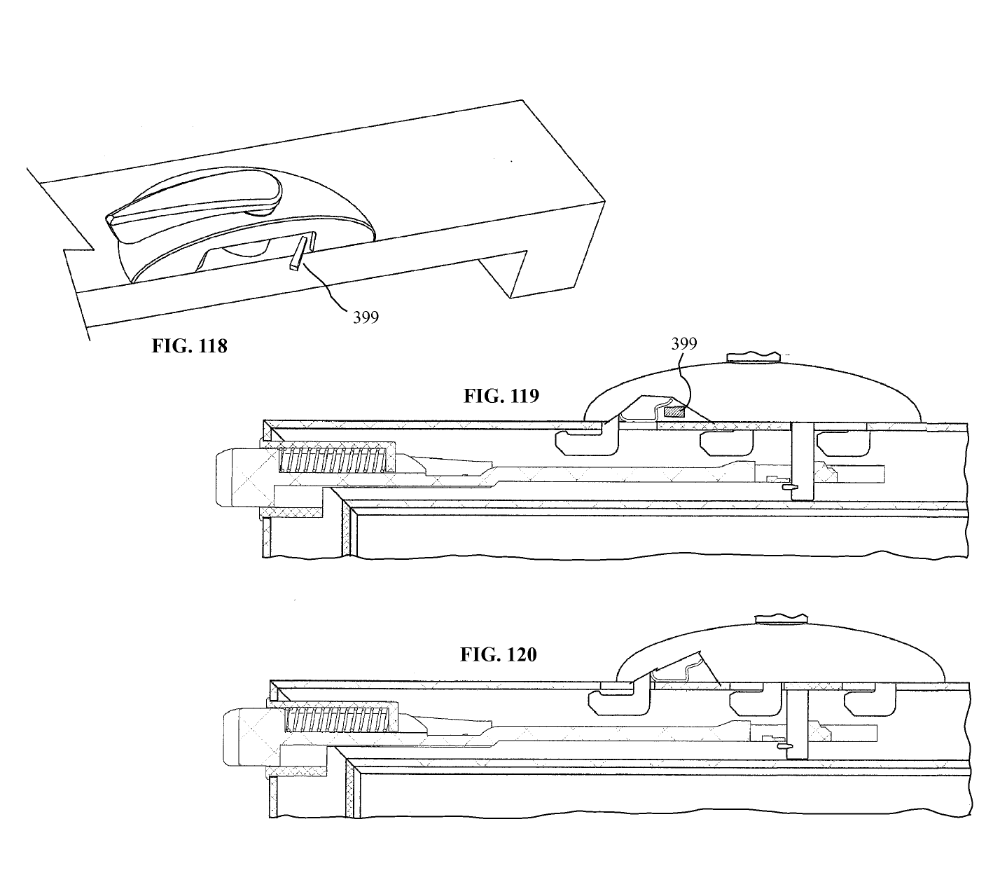

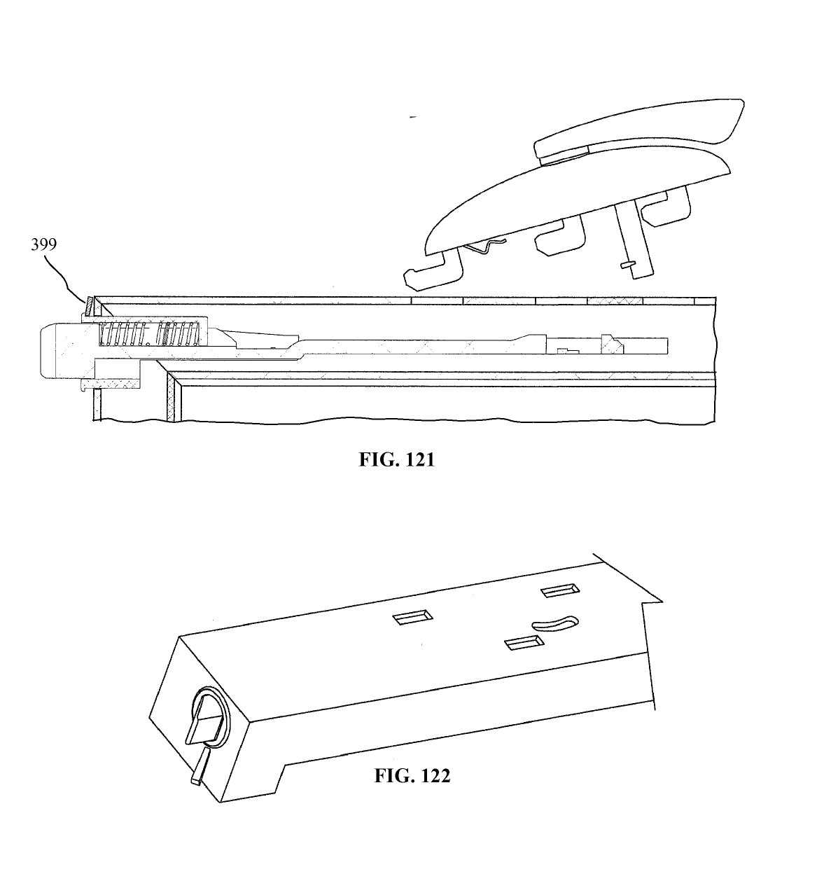

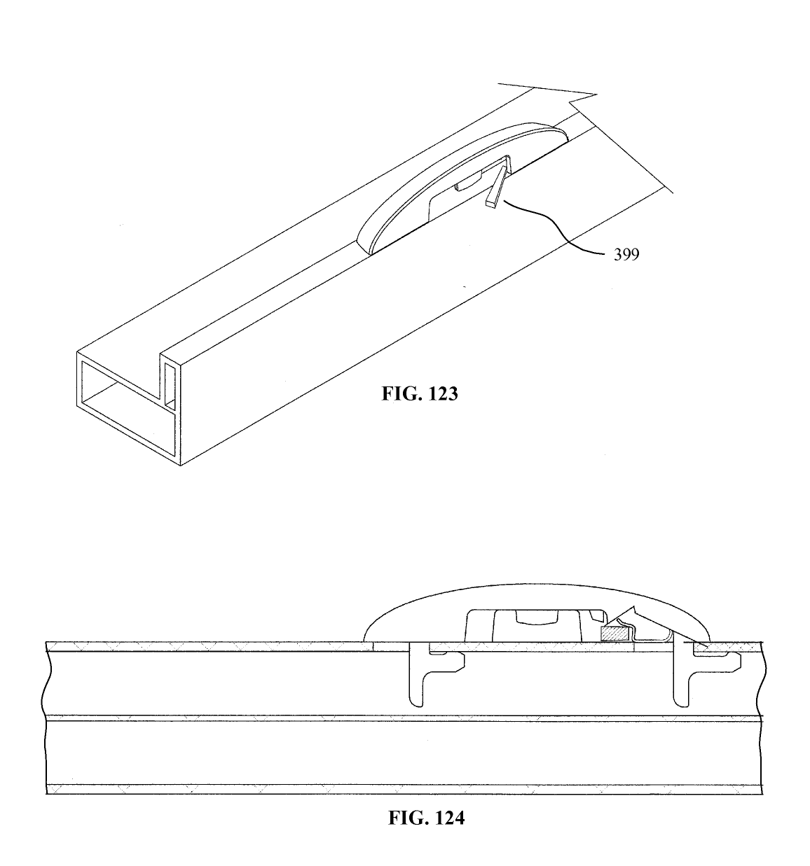

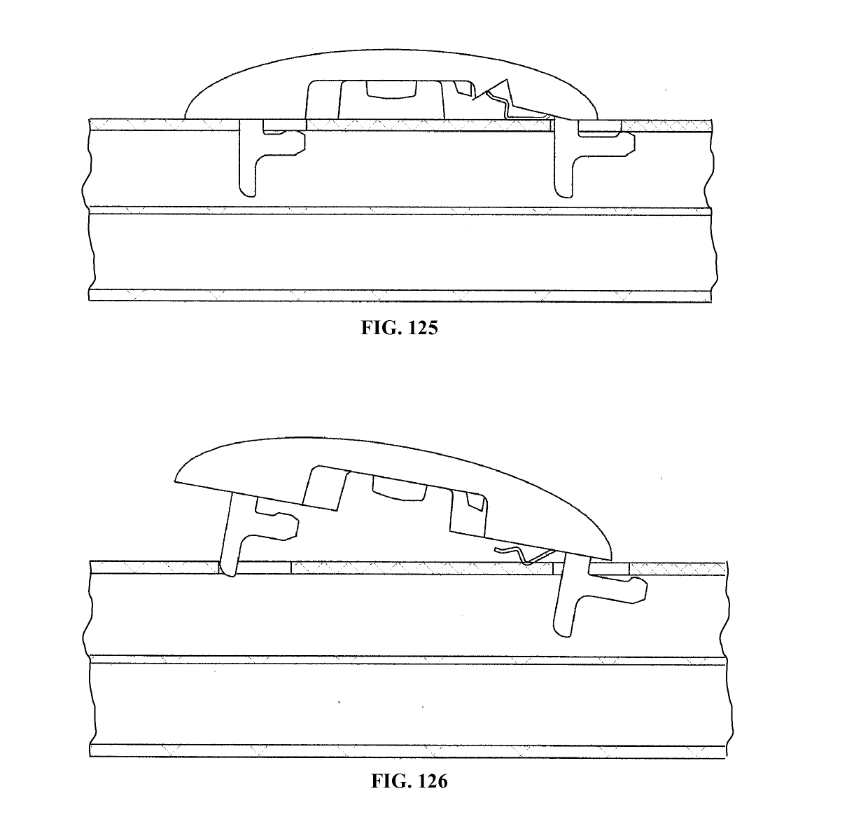

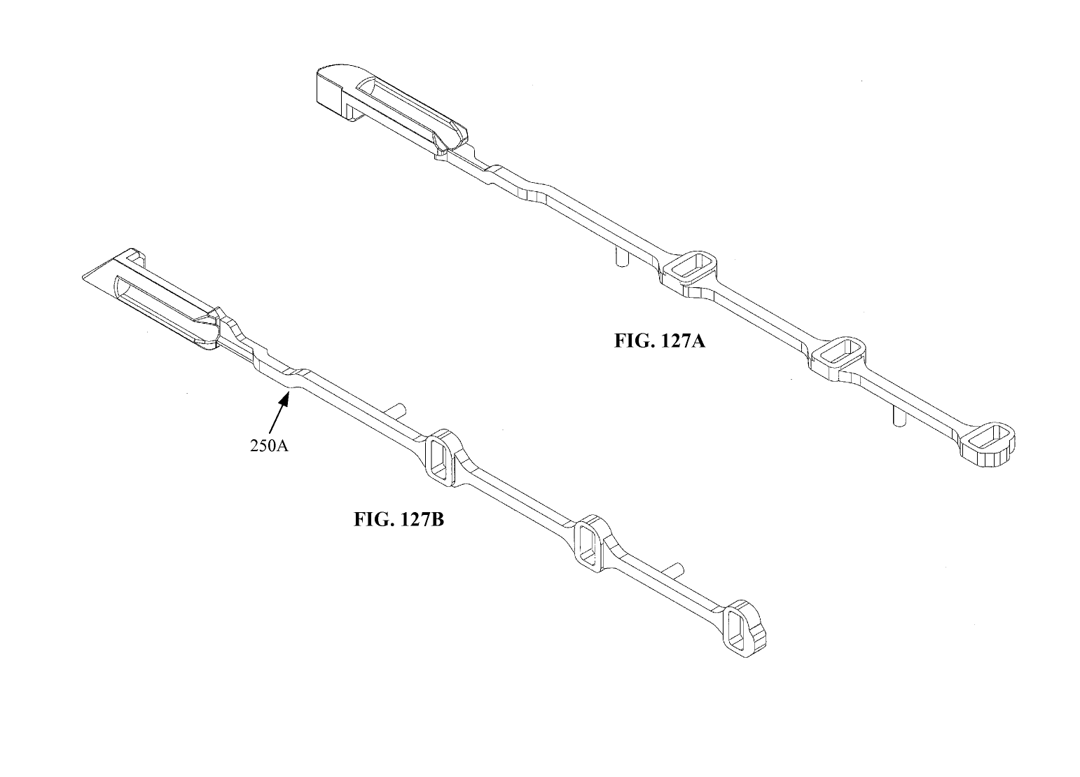

Uninstalling of the lock assembly 100 is shown in FIGS. 118-122, and may be effectuated using a slender and/or a pointed object, such as a thin screw-driver blade, or a knife blade, or a simple pry tool, such as tool 399. As illustrated in FIGS. 118 and 119, the pry tool 399 may be used to remove the sash lock assembly 100 by deflecting the engagement spring 94 back towards the interior of the housing 10 to disengage its legs 98 and 99 from the rail opening 315. Thereafter, removal may be effectuated by sliding the housing away from stile 302, and by pivoting the lock assembly to remove the legs 15, 16, and 17, as well as the post 77 of lever arm 70, from the corresponding openings in the meeting rail 301.

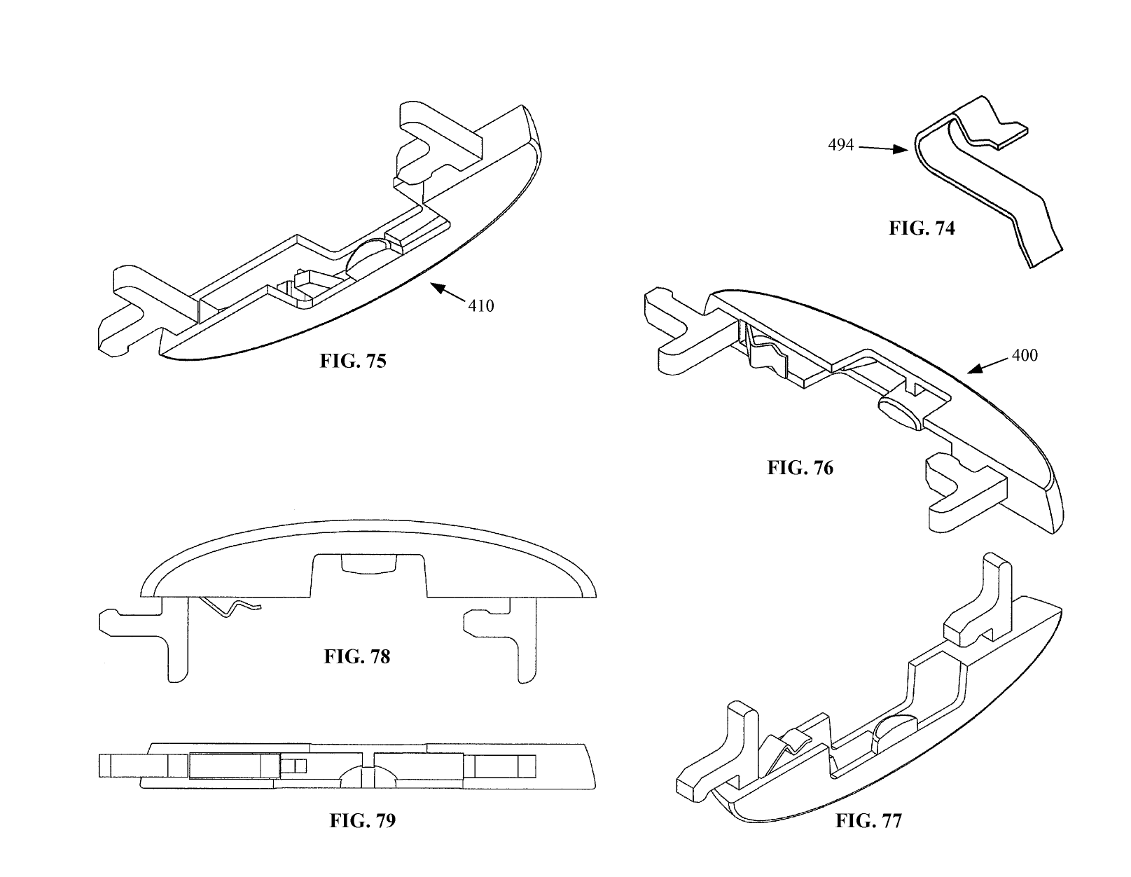

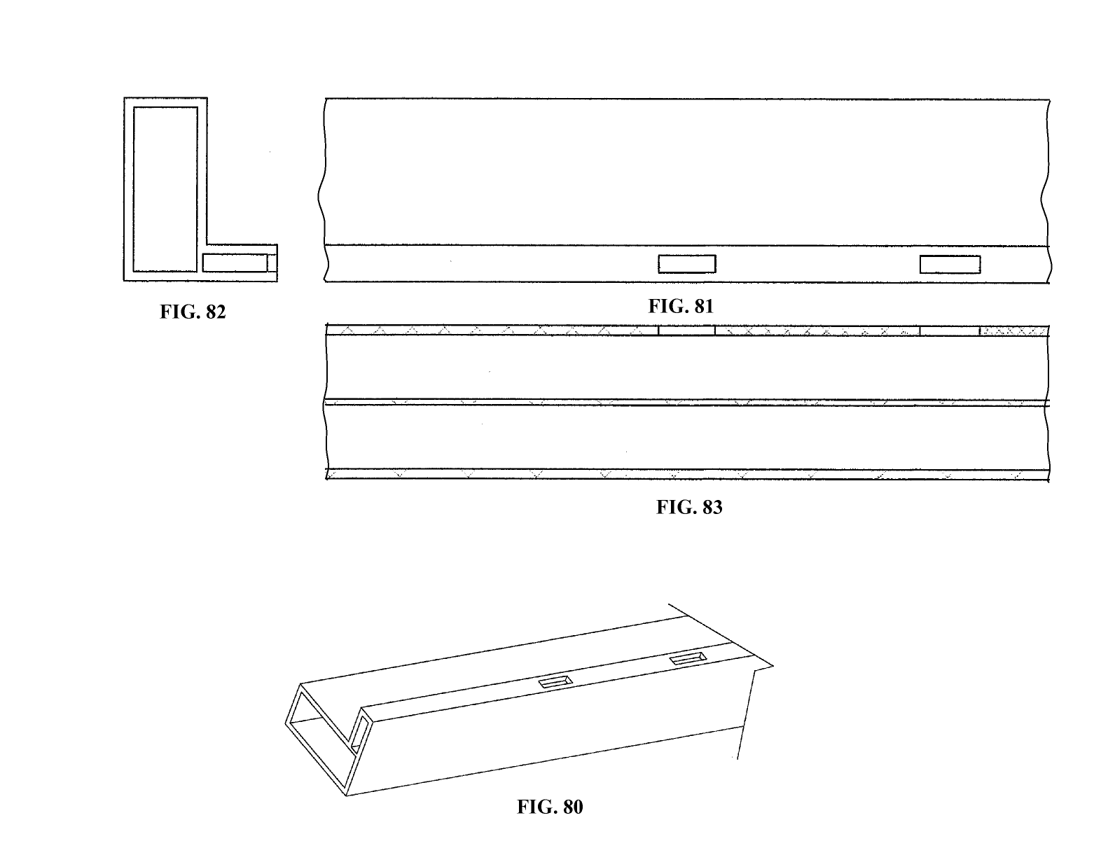

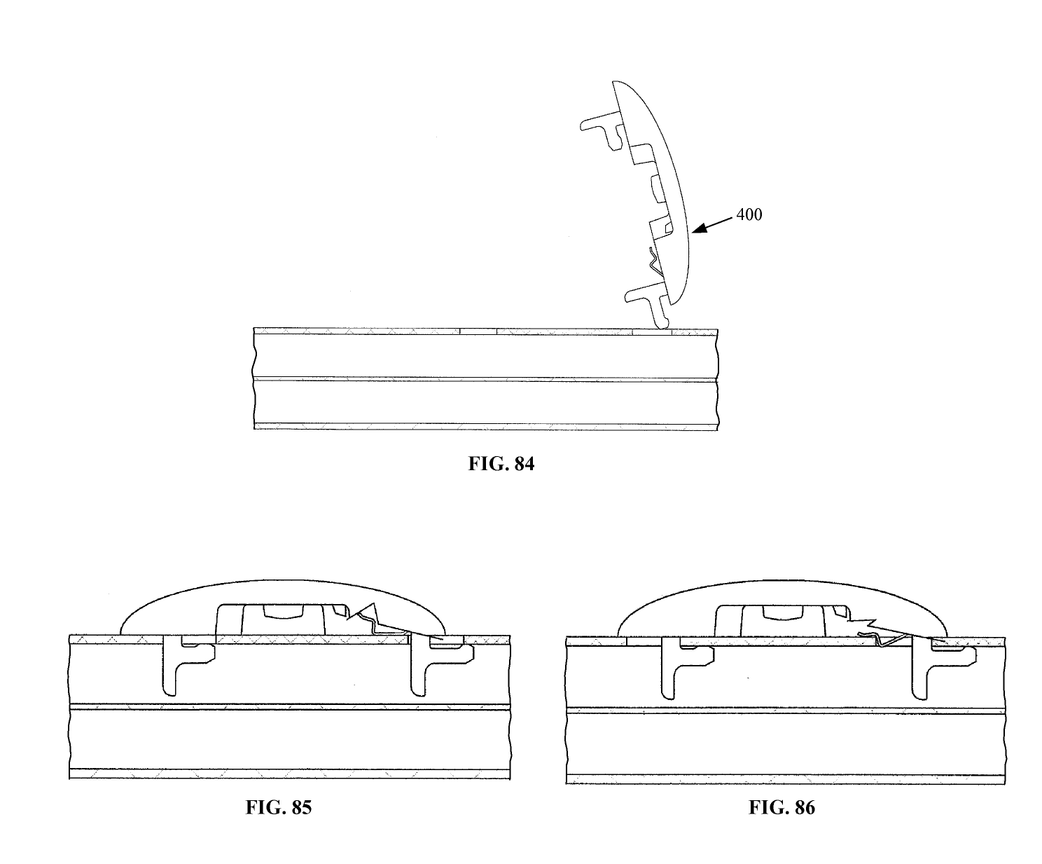

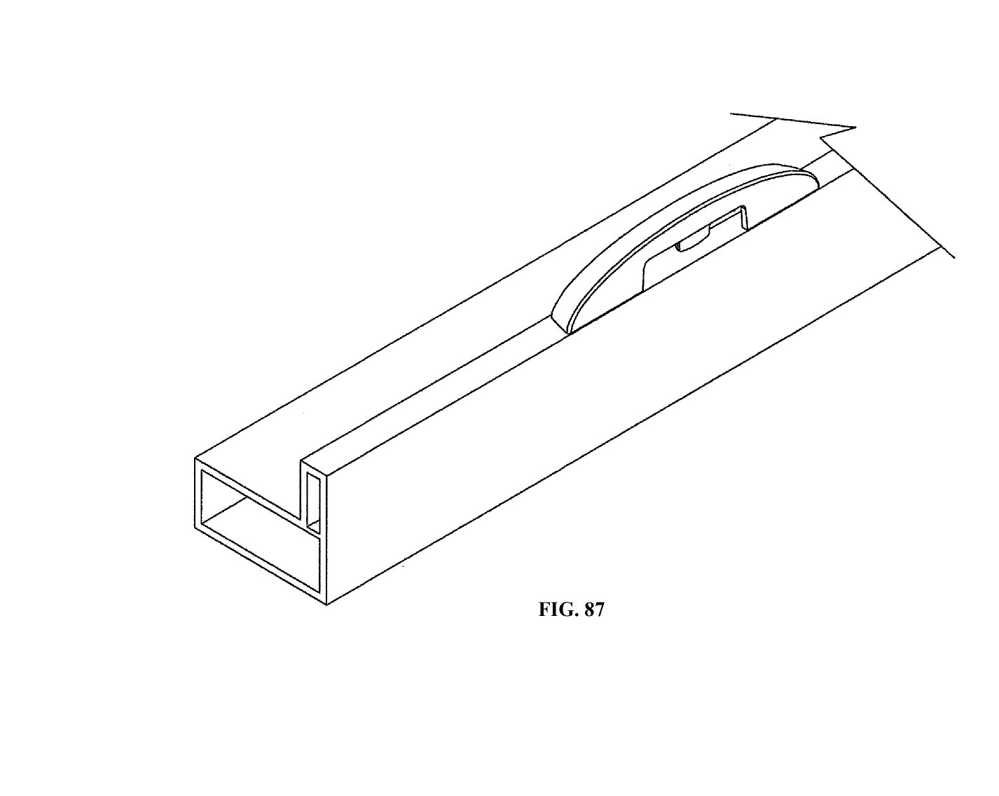

A keeper assembly 400 may be constructed similar to the lock assembly 100, using a housing 410 and an engagement spring 494, as seen in FIGS. 74-77. Keeper assembly 400 may be installed upon the master window frame (or upon the meeting rail of an upper sliding sash window for a double hung window), similar to the installation of the sash lock assembly 100, and is shown in FIGS. 80-87. The keeper assembly 400 may also be uninstalled from the master window frame in a similar process as for the uninstalling of the sash lock assembly 100, and is shown in FIGS. 123-126.

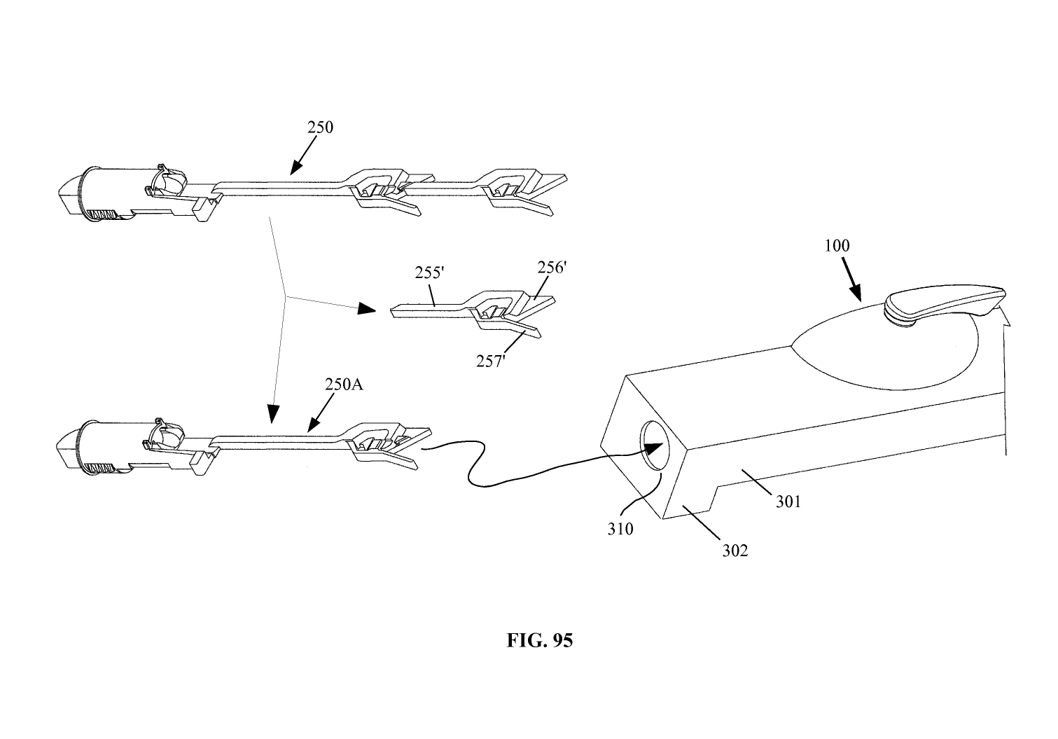

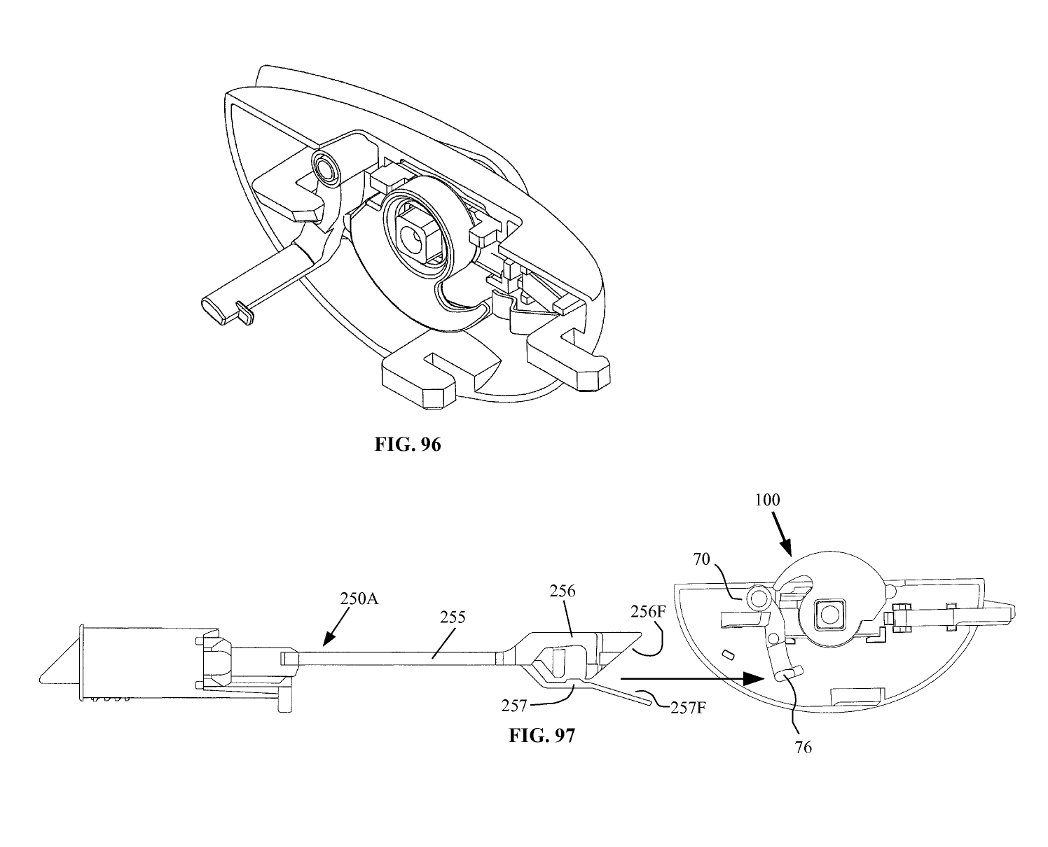

Installation of the latch assembly 200 is shown initially in FIG. 95, where the latch member 250 may be size adjusted, by removal of the secondary beam 255′ and corresponding secondary fixed/flexible funnel member (256′ and 257′), to form latch assembly 200A. The latch assembly 200A may be inserted through the opening 310 of the frame of sliding sash window 300. As seen in FIG. 97, the insertion of the latch assembly 200A through the selectively positioned opening 310 in the rail of the sliding sash window will accomplish mating of the beam 255 of the latch assembly with the post 76 of lever arm 70 of the lock assembly 100, using the fixed funnel member 256 and the flexible funnel member 257 of the latch assembly.

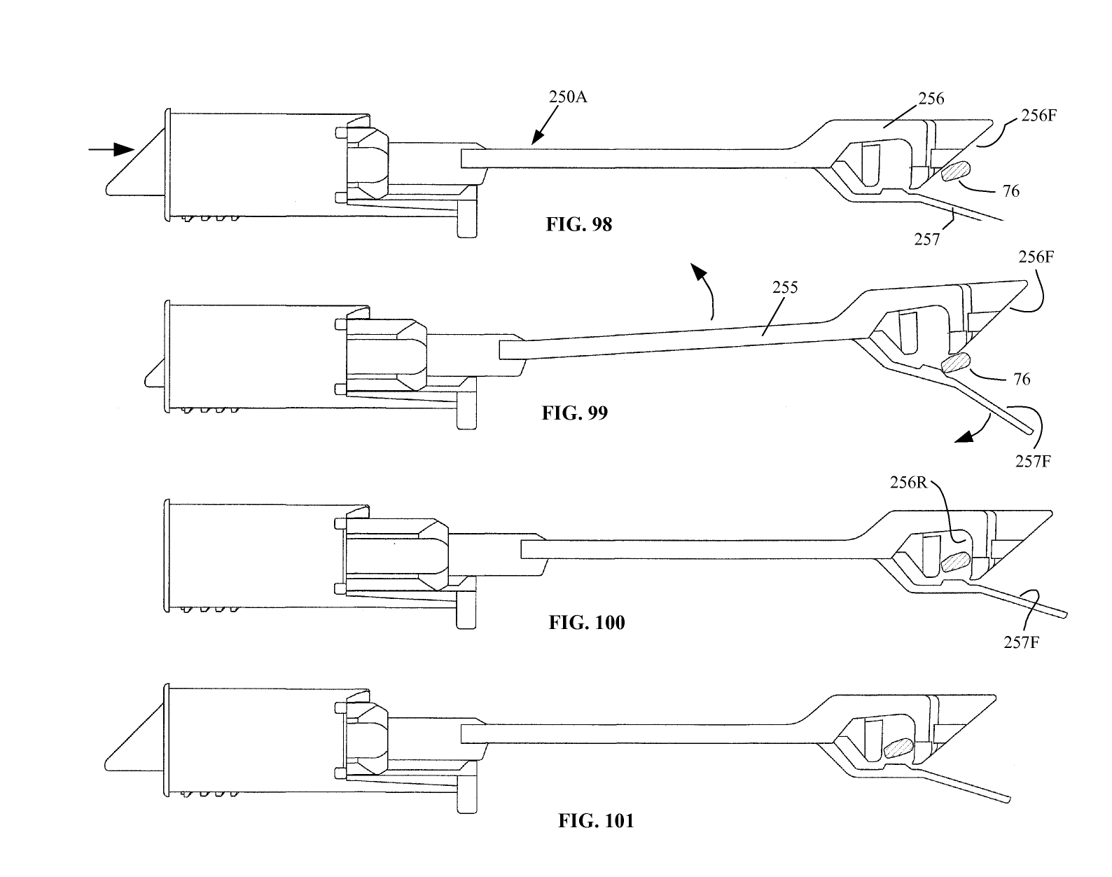

As the latch assembly 250A is advanced through the opening 310 in the rail, as seen in FIG. 98, the fixed funnel member will be positioned so that its angled funnel surface 256F will contact the post 76 of lever arm 70. Continued advancement of the latch assembly 250A through the opening 310 in the rail (note the apex of the tongue 255 withdrawing into the latch housing 210), will result in the beam 255 deflecting in a first direction, as shown by the arrow in FIG. 99, as the post 76 moves farther down the angled funnel surface 256F of the fixed funnel member 256. When the post 76 reaches the angled funnel surface 257F of the flexible funnel member 257, it will cause the flexible funnel member to deform in a second direction being generally opposite to which the beam 255 had been deflected, and will therefore cause separation between the fixed funnel member 256 and the flexible funnel member 257. When the separation is sufficient, the post 76 will pass therebetween, and will enter the curved recess 256R of the fixed flexible member, after which the flexible funnel member will return to its undeflected position in proximity to the fixed flexible member 256, as seen in FIG. 100. Upon removal of the force that had been applied to the tongue 255 to cause capture of the post 76 within the recess curved recess 256R of the fixed funnel member 256, the tongue will be biased outward once again by spring 291, as seen in FIG. 101.

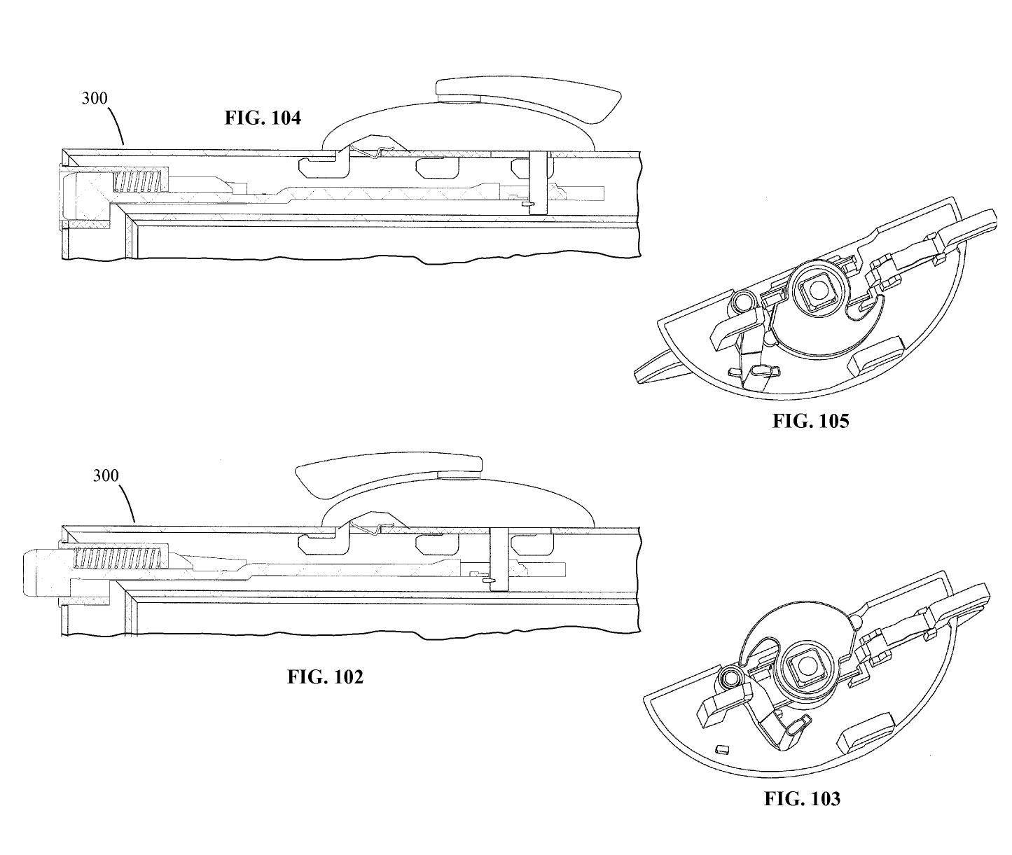

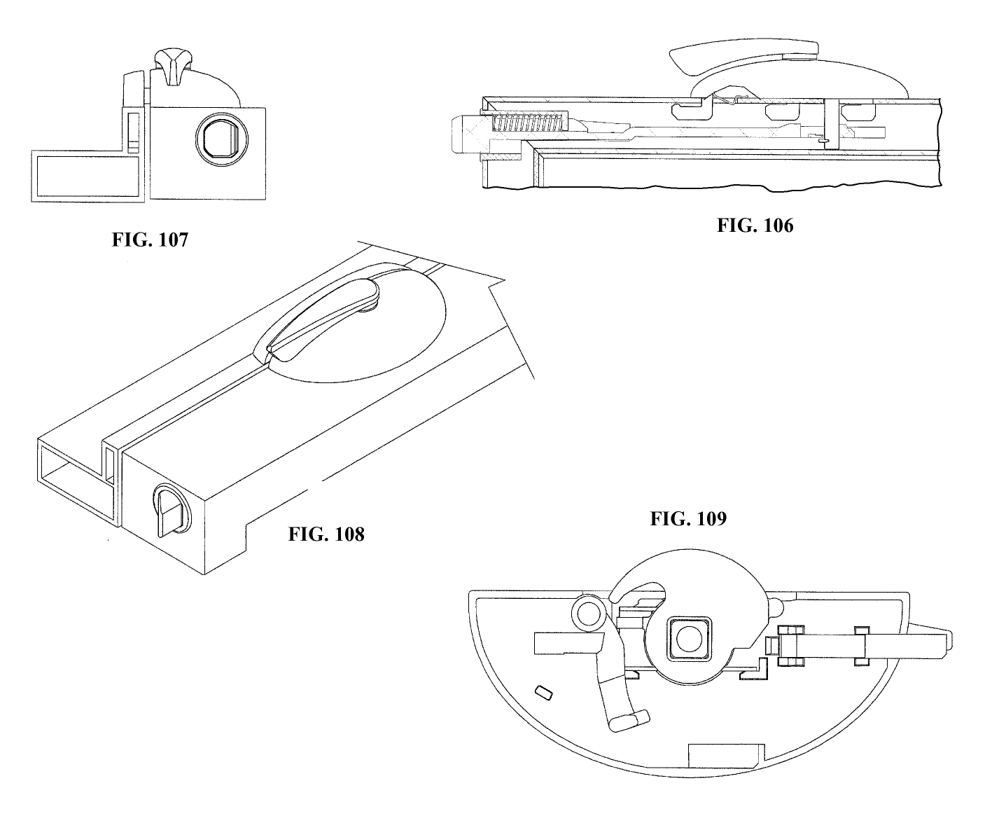

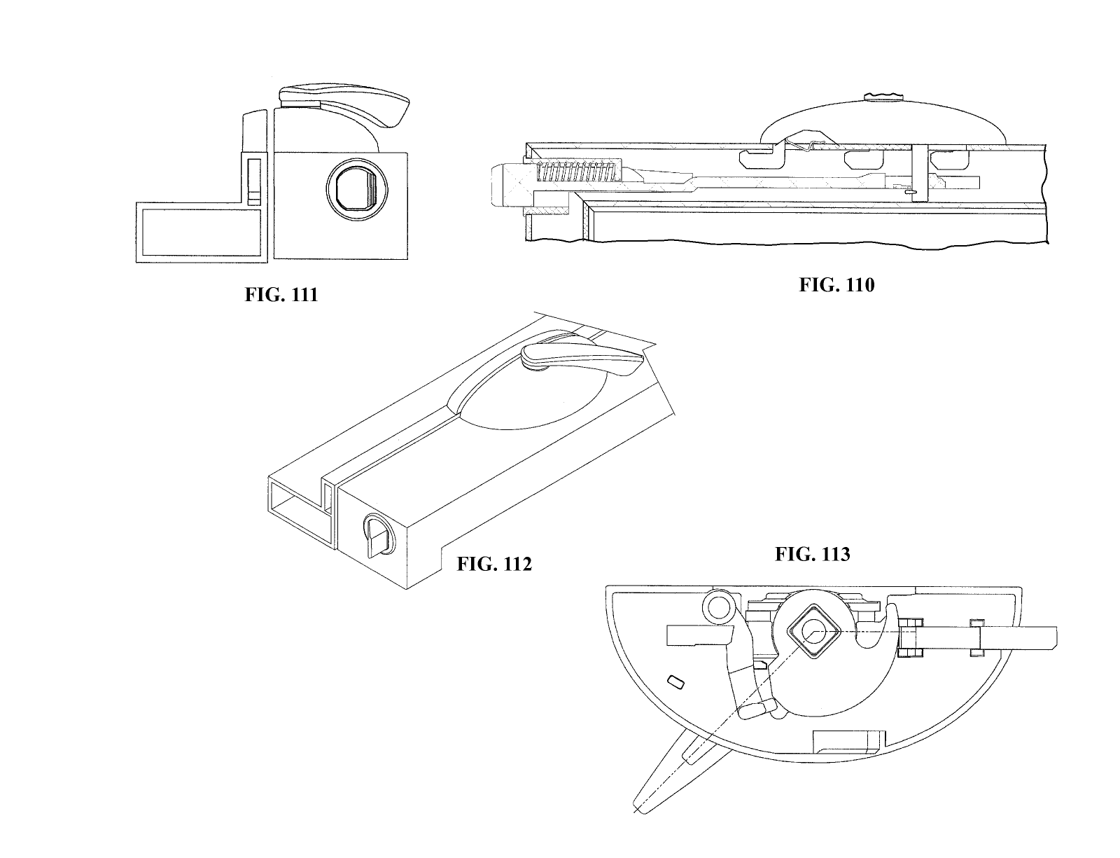

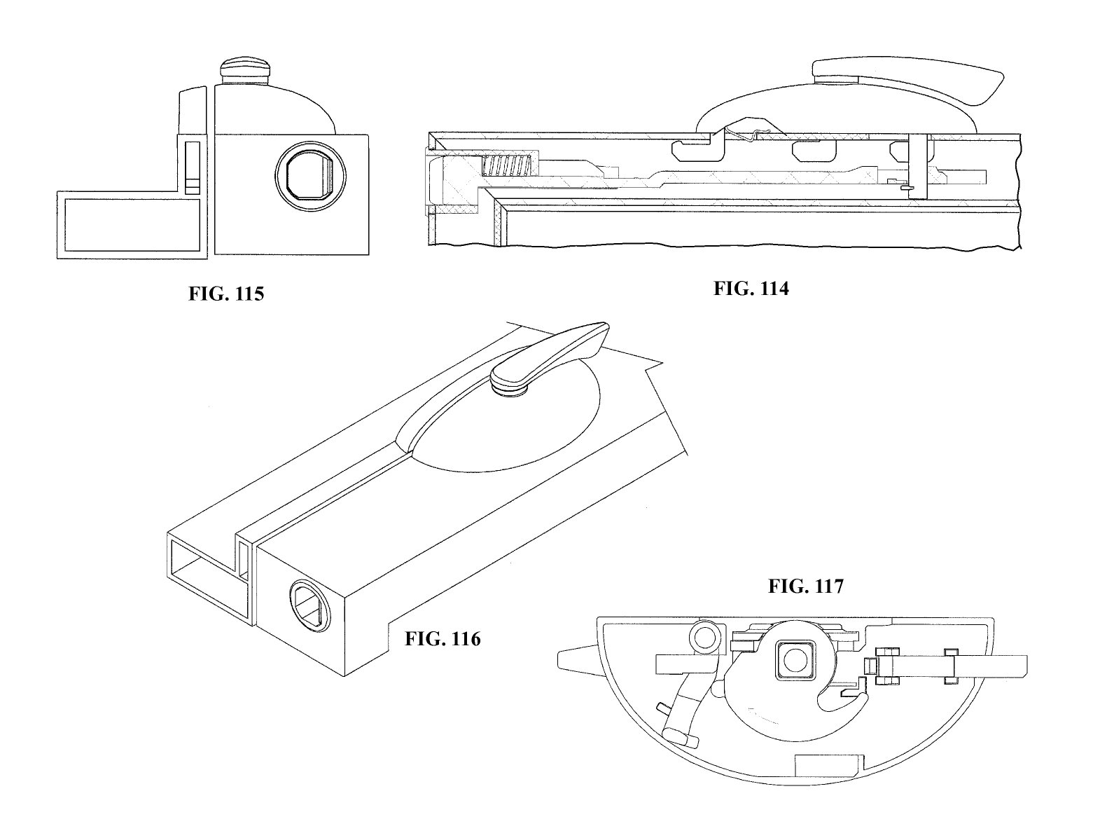

The integrated sash lock/tilt latch fastener, which includes sash lock assembly 100 and latch assembly 200 (FIG. 1A), is shown installed in the sliding sash window 300, and in the locked and latched position within FIG. 102, and in the unlocked and unlatched position within FIG. 104. A series of additional views showing the integrated sash lock/tilt latch fastener installed upon the sliding sash window 300, and in the locked and latched position, are shown within FIGS. 106-108. A series of views showing the integrated sash lock/tilt latch fastener installed upon the sliding sash window 300, and in the unlocked and latched position, are shown within FIGS. 110-112. A series of views showing the integrated sash lock/tilt latch fastener installed upon the sliding sash window 300, and in the unlocked and unlatched position, are shown within FIGS. 114-116.

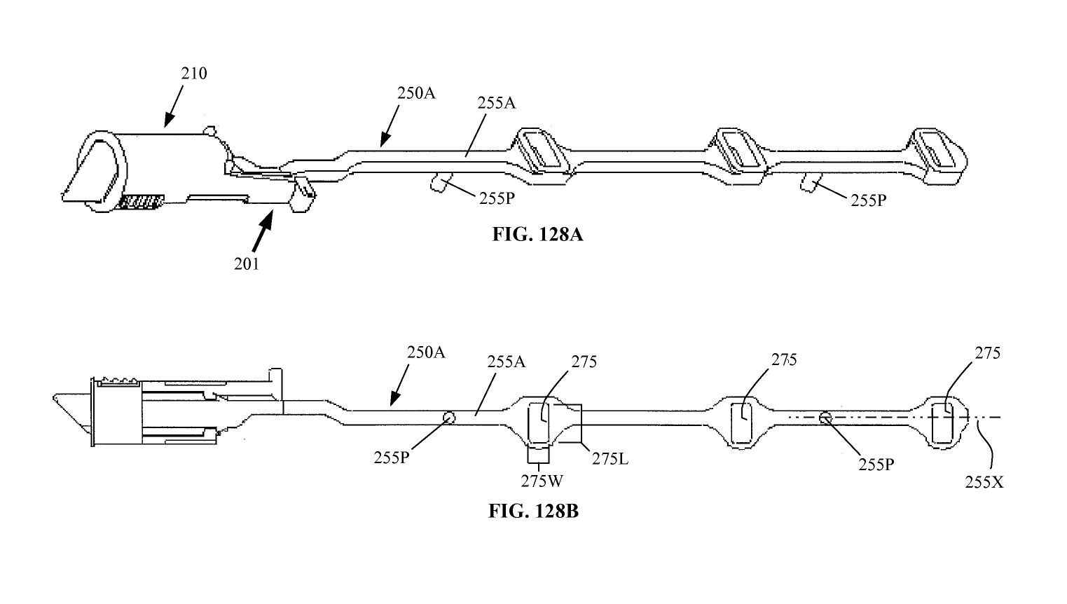

Improvements to the interconnection between the sash lock assembly 100 and latch assembly 200 for the integrated sash lock/tilt latch fastener shown installed in the sliding sash window 300 of FIG. 110, may be obtained through the replacement of latch assembly 200 with latch assembly 201. Latch assembly 201 is shown in FIGS. 128A and 128B, and may similarly include the use of the housing 210 and a biasing member, which may be helical compression spring 291. However, latch assembly 201 may include a latch member 250A instead of latch member 250.

Latch member 250A may be formed as seen in the perspective view of FIG. 128A and the top view of FIG. 128B. The latch member 250A may be formed to have a tongue similar to latch member 250, however, it may have a beam 255A that is formed differently than beam 255 of latch member 250. The beam 255A may, as seen in FIG. 128B, have one or more openings 275 formed to pass through the beam from the top surface of the beam through the bottom surface, such that when the latch assembly is installed through the side of the sash window frame and the beam 255A is within the hollow meeting rail, the through-opening 275 may be vertically oriented. (It should be noted that the use within this disclosure of the terms “vertical” and “horizontal” are not intended to limit other possible configurations/uses of the combination sash lock/tilt latch embodiments taught herein, particularly because certain modem architectural designs utilize windows that are not oriented with respect to that reference frame, and may instead, for example, be at an angle with respect to a vertical plane. However, those terms are useful in describing the standard sliding/tilting sash window illustrated throughout the exemplary Figures provided herein).

Each of the one or more openings 275 may be particularly shaped and oriented to provide for selective engagement of the post 76 of lever arm 70 of the lock assembly 100 therein. As seen in FIG. 128B, the opening 275 may be an elongated shape, which may, for example, be generally rectangular-shaped, or diamond-shaped, etc., and may correspond to the cross-sectional shape used for the post 76 of lever arm 70.

To be illustrative, the opening 275 in beam 255A in FIG. 128A is shown with a rectangular shape. The elongated opening may be oriented so that the longer direction of the opening is substantially perpendicular to the axis 255X of the beam 255. The rectangular opening 275 may therefore have a length 275L extending substantially normal to the axial direction 255X of the beam, and a width 275W extending substantially parallel to the axial direction of the beam. The internal corners of the rectangular opening 275 may be filleted (i.e., formed with a concave junction). The generally slender beam 255A may thus transition to widen in proximity to the opening(s) 275, and may form peripheral walls to provide sufficient structural integrity for the latch member, as the size of the opening is largely driven by the shape and the required size of the post 76 of lever arm 70 of the lock assembly 100.

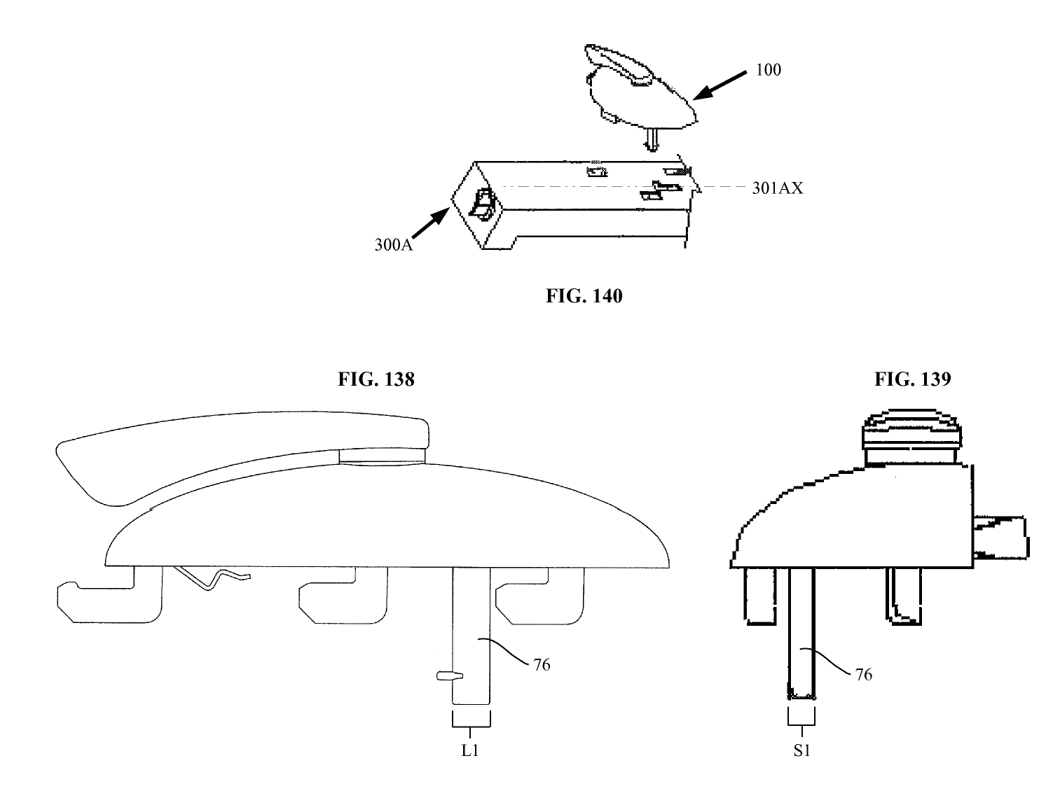

The post 76 of lever arm 70 is shown in detail in FIGS. 25-32. The elongated cross-sectional shape used for the post 76 may be a somewhat irregular shape, or it may be a diamond shape or a substantially rectangular shape that may have rounded exterior corners. Other cross-sectional shapes may also be suitably utilized to form the post, such a racetrack shape, a clothoid shape, and an elliptical shape, each of which may be suitable, as they would not tend to adversely affect the beam 255A when received within the opening 275, as discussed hereinafter. A principle feature of the cross-sectional shape to be used for the post 76 may be, as seen in FIGS. 138 and 139, that it be an elongated shape having a long-transverse direction (i.e., L1) and a short-transverse direction (i.e., S1).

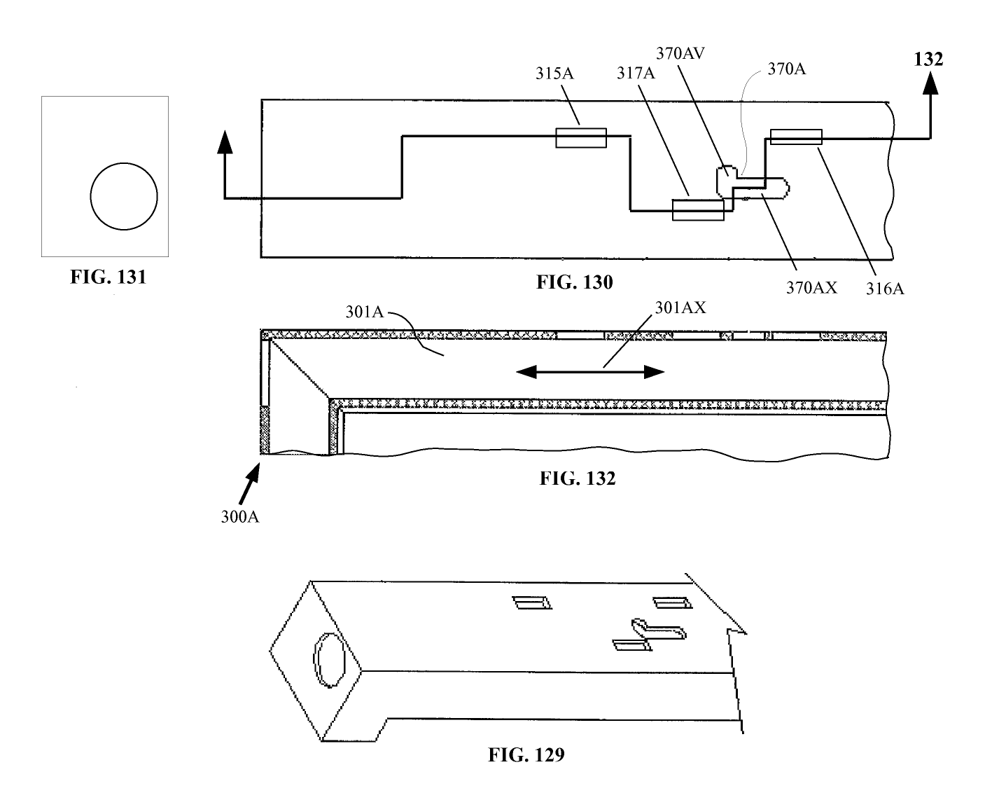

This elongated cross-sectional shape of the post 76 may work in concert with the rectangular shaped opening 275, with respect to initial insertion of the post therein, and its subsequent operation relative to the walls of the opening. The post 76 may be received within the opening 275 when the lock assembly 100 is mounted to the top of the meeting rail of the sash window. A suitable series of openings formed in the top of the meeting rail for mounting of the sash lock thereto is shown within FIGS. 129-131, and may similarly include a first opening 315A, a second opening 316A, a third opening 317A, and a fourth opening 370A. The fourth opening 370A may generally be elongated along the axial direction 301AX of the meeting rail 301A (FIG. 132), to accommodate pivotal movement of the lever arm 70 therein, as discussed hereinabove with respect to the lock assembly 100 and meeting rail 301. In addition, the fourth opening 370A may be formed of an elongated axial opening 370AX, and shorter elongated portion 370AT being elongated in a direction that is transverse to the axial direction 301AX of the meeting rail 301A.

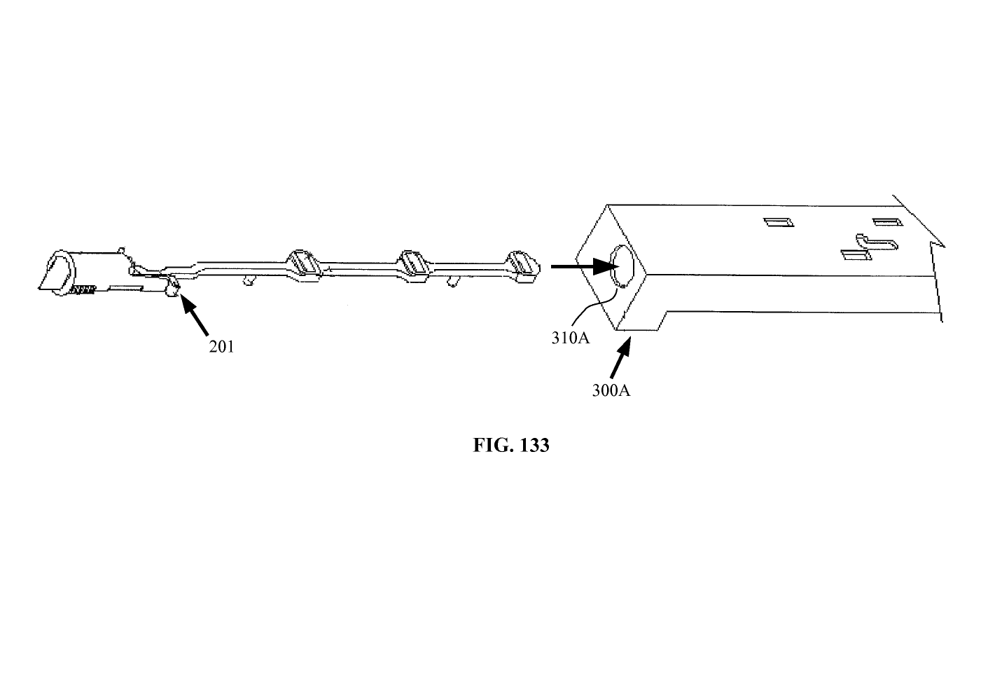

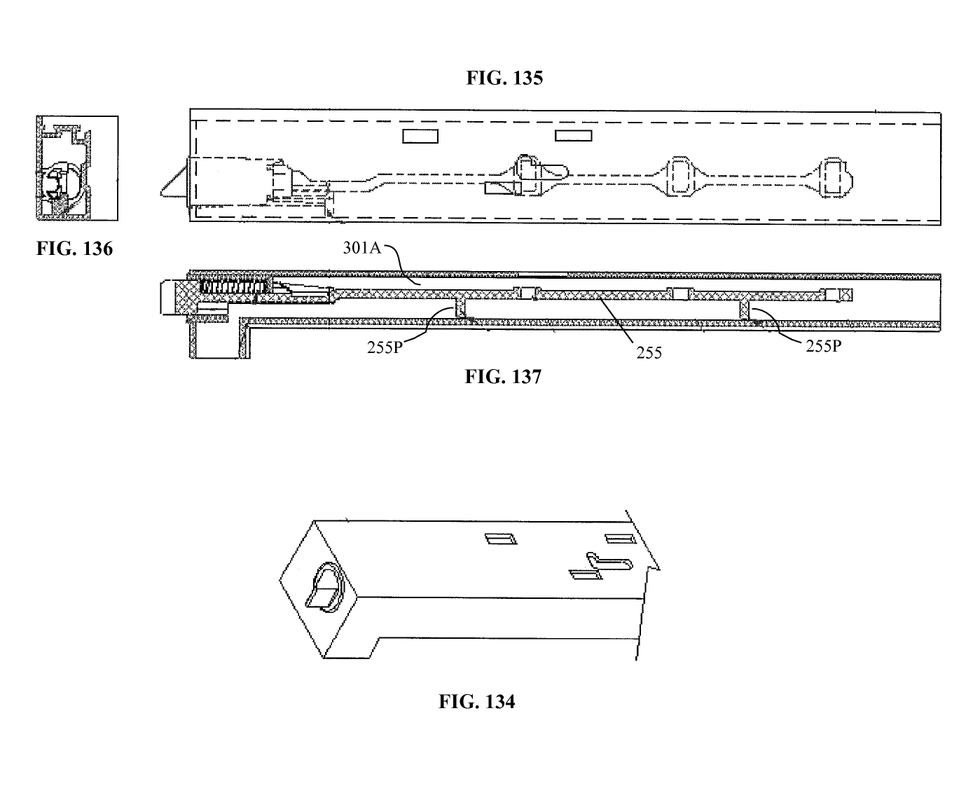

While the latch member 201 may be received within the opening 310A of the sliding sash window 300A (FIG. 133) the same as with latch member 200 and window 300, the latch member 201 may operate somewhat differently therein (see e.g., FIGS. 134-137), and the securing of the lock assembly 100 to the meeting rail 301A may also be somewhat different.

Initial positioning of the lock assembly 100 for its mounting to the sash window 300A is seen in FIG. 140, in which the housing of the lock assembly is positioned substantially transverse to the axial direction 301AX of the meeting rail 301A. Such initial positioning may also serve to orient the long transverse direction of the post 76 of lever arm 70 to similarly be perpendicular to the axial direction 301AX of the meeting rail 301A, where it may be generally in-line with the shorter elongated portion 370AT of the elongated fourth opening 370A in the top of the meeting rail 301A.

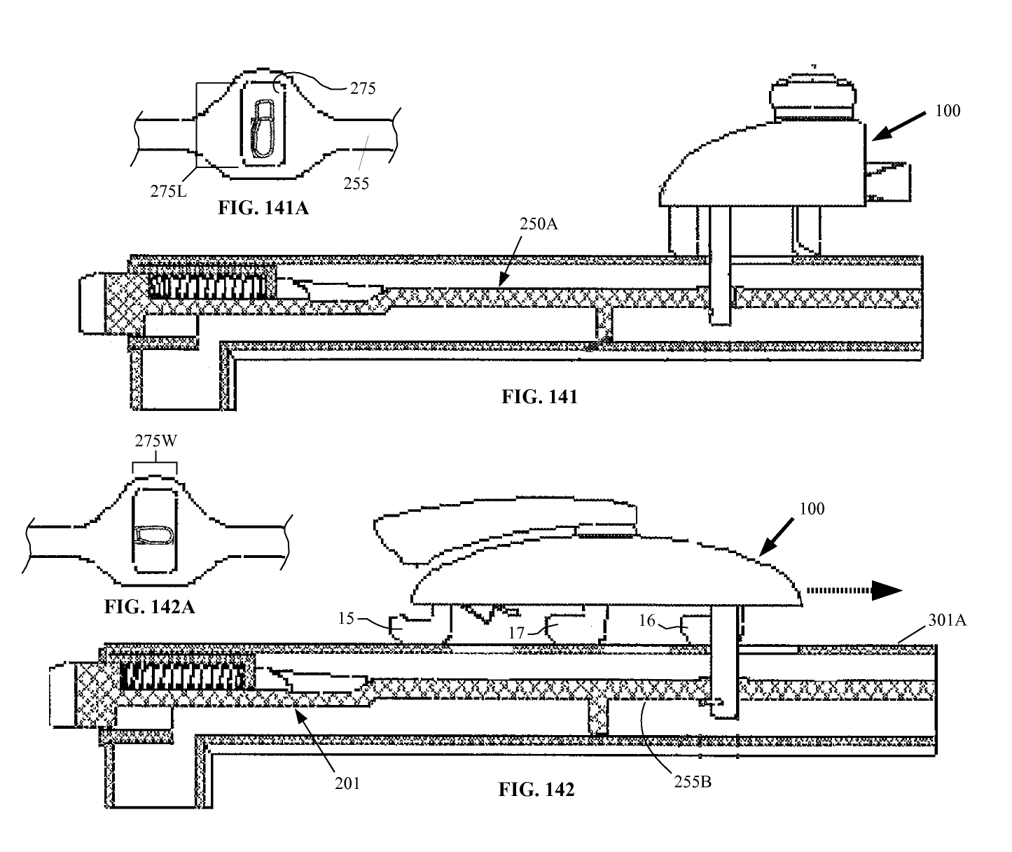

With the long transverse direction of the post 76 of lever arm 70 being oriented to be in-line with the shorter elongated portion 370AT of the elongated fourth opening 370A, the lock assembly 100 may be dropped “vertically,” as seen in FIG. 141, so that the post 76 is first received through the opening elongated portion 370AT of opening 370A, and then through the opening 275 in the beam 255A of the latch member 250A. This may result by the length of the beam 255A and the location of the opening 275 therein being coordinated with the positioning of the openings 315A, 316A, 317A, and 370A in top of the meeting rail 301A, so that the elongated portion 370AT of opening 370A in the meeting rail 301A is directly above the corresponding elongated opening 275 in the beam 255A of the latch member 201.

With the post 76 of lever arm 70 received through the opening 275 in the beam 255A of the latch member 250A, as seen in FIG. 141, the latch assembly may be rotated roughly 90 degrees, as seen in FIG. 142. The joining of the transverse elongated portion 370AT of the opening 370A in the meeting rail with the axial portion 370AX may be sufficient to permit rotation of the elongated cross-section of the post 76 of lever arm 70 therein. In addition, the length 275L of the rectangular opening 275 in the beam 255 may be slightly oversized in comparison to the combination of the elongated cross-sectional shape of the post 76 and the protrusion 77 protruding therefrom, as seen in FIG. 141A. The rounded corners of the rectangular cross-section for the post 76 (or the alternative use of the racetrack shape, the clothoid shape, or the elliptical shape) may each be advantageous, as they would not tend to gouge or scrape the beam when initially rotated within the opening 275, or thereafter when the lock assembly is actuated and the post is driven by the cam to actuate the beam and tongue of the latch member 250A.

After the lock assembly 100 has been rotated relative to the meeting rail, as seen in FIG. 142, the extent of the elongated cross-sectional shape of the post 76 may tend to occupy substantially the entire width 275W of the opening 275 in the beam 255, as seen in FIG. 142A. In addition, the protrusion 77 protruding from one side of the post 76 is now disposed beneath the bottom surface 255B of the beam 255, and the post of lock assembly 100 may now be captive with respect to the latch member 201.

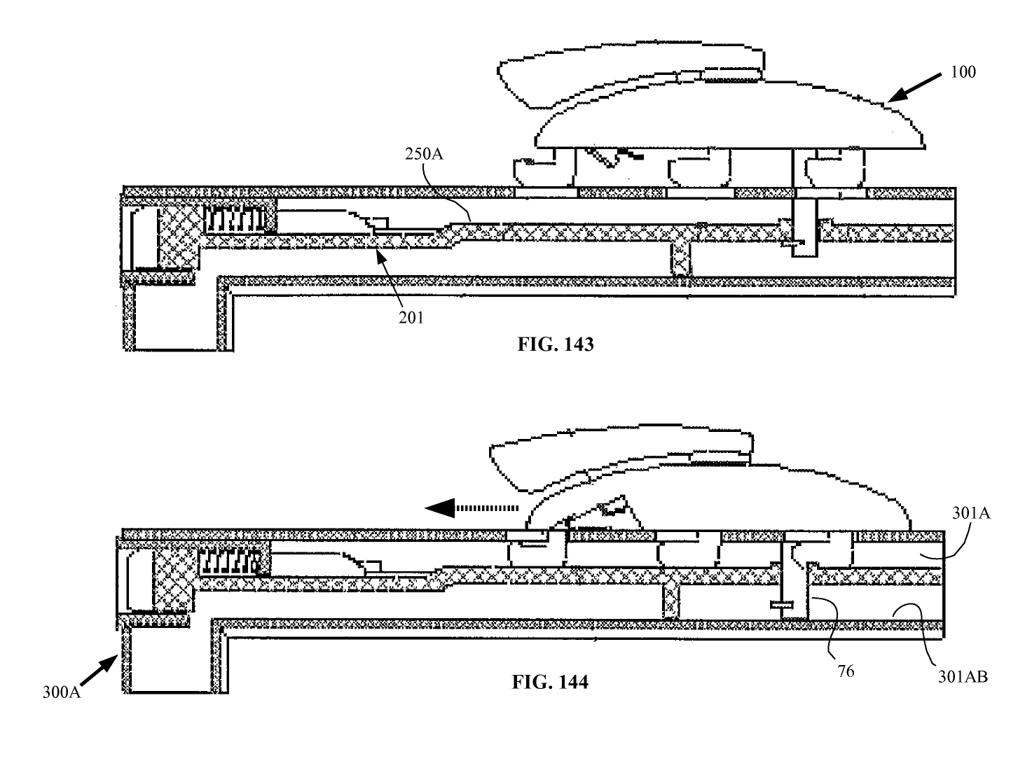

As seen in FIG. 142, the first, second, and third legs, 15, 16, and 17, of the housing of the lock assembly 100 are aligned with the first, second, and third openings (315A, 316A, and 317A) in the top of the meeting rail 301A (i.e., the axial direction of the legs is aligned with the axial direction of the openings), but are laterally displaced therefrom. Therefore, the lock assembly 100 may be translated away from the stile of the window frame, as indicated by the arrow in FIG. 142, so that the legs (15, 16, and 17) of the housing are moved to become adjacent to the openings (315A, 316A, and 317A), as seen in FIG. 143. Note that in translating the lock assembly 100, the post 76 that is captive within the opening 245 of the beam 255 of the latch assembly 250A causes the latch member 250A to also translate, and the tongue to be retracted.

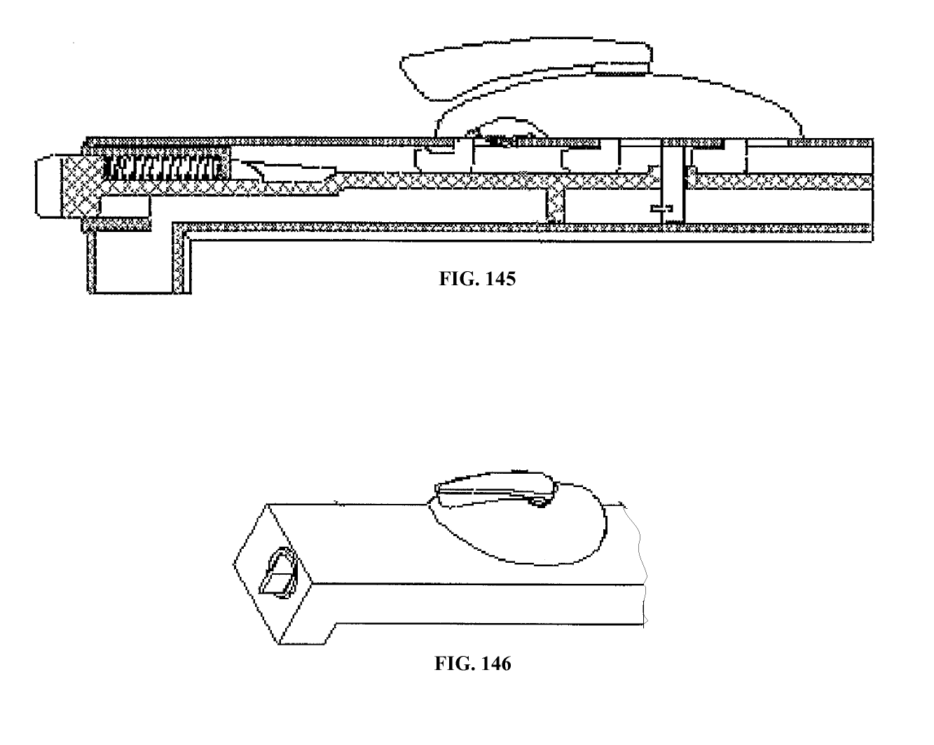

The lock assembly 100 may then be advanced toward the meeting rail, so that the legs (15, 16, and 17) are received through the openings (315A, 316A, and 317A), as seen in FIG. 144. The lock assembly 100 may then be reverse-translated, as indicated by the arrow in FIG. 144, so that the legs (15, 16, and 17) of the housing are moved within the openings (315A, 316A, and 317A) to become engaged with the top wall of the meeting rail, as seen in FIG. 143. The engagement spring 94, as discussed hereinabove, may move into the rail opening 315A, back towards its undeflected position, until the legs 98 and 99 of the engagement spring 94 may engage the edge of the rail opening to secure the lock assembly to the sash window frame, as seen in FIGS. 145 and 146.

Other features of the latch member 250A may enable improved operation of the integrated sash lock and tilt latch, and coupling of the lock assembly to the latch member. The length of the post 76 may be selected so that the end of the post of the lever arm 70 is then in very close proximity to, or contacting, the bottom wall 301AB of the meeting rail 301A (FIG. 144), which may further preclude the separation of the beam from the post, even in the absence of the use of the protrusion 67 on the post 66 of the lever arm 70 of the lock assembly 100. Moreover, the beam 255 of the latch member 250A may be formed to include at least one vertical post 255P that may protrude down from the bottom surface of the beam. The post 255P, which may be cylindrical, may be formed of a selective length so as to contact the bottom wall 301AB of the meeting rail 301A to provide support for the beam 255 to be at a substantially horizontal position, which may be a substantially central position within the hollow meeting rail of the sash window. This may further serve to prevent disengagement of the post 76 of the lever arm 70 from the opening 275, in addition to locating the end of the post 76 in proximity to the bottom of the meeting rail, and it may also serve to provide support to the beam 255 to facilitate the initial insertion of the post 76 though the opening 275 in the beam.

The latch member 250A, as seen in FIG. 128B, may also be formed to have multiple openings 275 along the length of the beam 255, which may permit the same latch assembly to be universally suited for use on windows of various different sizes, where the openings 315A, 316A, 317A, and 370A in top of the meeting rail 301A may be positioned at a different distance from the stile for each different window size. The cross-section of the beam 255 between the openings 275 may be reduced in thickness to preclude excessive use of plastic or other material needed to form the part, while multiple posts 255P may be used to provide support for the beam. As seen in FIG. 137, two posts 255P may be used to support the length of beam where three openings 275 are utilized.

The examples and descriptions provided merely illustrate a preferred embodiment of the present invention. Those skilled in the art and having the benefit of the present disclosure will appreciate that further embodiments may be implemented with various changes within the scope of the present invention. Other modifications, substitutions, omissions and changes may be made in the design, size, materials used or proportions, operating conditions, assembly sequence, or arrangement or positioning of elements and members of the preferred embodiment without departing from the spirit of this invention.

We claim:

1. A combination locking and tilt latching fastener, for use on a frame of a sash window configured to slide and tilt with respect to a master window frame, said fastener comprising:
a lock assembly configured to be mounted to the top surface of a hollow meeting rail of the sash window frame, said lock assembly comprising: a housing; an arm pivotally mounted to said housing and configured to extend into the hollow meeting rail; and a cam pivotally mounted to said housing;
a latch assembly configured to be received through an opening in a side of the sash window frame, said latch assembly comprising a biasing means and a latch member, said latch member comprising a first end formed into a tongue portion, said biasing means configured to bias said latch member for said tongue portion to normally protrude out from the sash window frame opening; said latch member comprising a beam extending away from said tongue portion, said beam comprising at least one through-opening from a top side of said beam through a bottom side of said beam, said beam comprising at least one post, of a selective length, configured to protrude down from said bottom side;
wherein said pivotal arm of said lock assembly is configured to be selectively received through one of said at least one opening in said beam, said one opening being positioned below said lock assembly mounting position on the sash window meeting rail; and
wherein a first position for said pivotal cam is configured to engage a keeper on the master window frame to lock the sliding sash window, a second cam position is configured to permit sliding of the sash window, and a third cam position is configured to actuate said pivotal arm to drive said beam of said latch assembly to oppose said biasing, to retract said tongue and permit tilting of the sash window.

2. The combination locking and tilt latching fastener according to claim 1, wherein said selective length of said post is configured to contact a bottom wall of said meeting rail to support said beam at a substantially central position within the hollow meeting rail of the window.

3. The combination locking and tilt latching fastener according to claim 2, wherein each of said at least one openings through said beam comprises a rectangular opening with a length of said rectangular opening extending substantially normal to an axial direction of said beam, and with a width of said rectangular opening extending substantially parallel to said axial direction of said beam.

4. The combination locking and tilt latching fastener according to claim 3,
wherein said arm of said lock assembly is formed with an elongated cross-sectional shape having a long-transverse direction and a short-transverse direction;
wherein said arm comprises a protrusion protruding from said arm in said long-transverse direction; and
wherein said pivotal arm of said lock assembly configured to be selectively received through said at least one opening comprises:
said lock assembly with said long-transverse direction of said elongated arm being oriented parallel to said length of said rectangular opening, to be received therethrough; and
said lock assembly thereafter rotated approximately 90 degrees, for said mounting upon the meeting rail, for said long-transverse direction of said arm of said lock assembly to thereby be oriented substantially parallel to said width of said rectangular opening, and with a portion of said beam forming said width of said rectangular opening being nested between said protrusion on said arm and said lock housing.

5. The combination locking and tilt latching fastener according to claim 4 wherein said elongated cross-sectional shape comprises a cross-sectional shape from the group of cross-sectional shapes consisting of: a racetrack shape, a clothoid shape, an elliptical shape, and a substantially rectangular shape.

6. The combination locking and tilt latching fastener according to claim 4, wherein said at least one opening comprises a plurality of openings in said beam of said latch member configured to universally accommodate said mounting of said lock assembly upon one of a corresponding plurality of mounting positions upon the top of the meeting rail for a corresponding plurality of different sized sash windows.

7. The combination locking and tilt latching fastener according to claim 6, wherein said plurality of openings through said beam comprise three openings spaced along a length of said beam; and wherein said at least one post comprises two posts spaced apart along said length of said beam to support said three openings.

8. The combination locking and tilt latching fastener according to claim 7, said lock assembly further comprising a leaf spring, and said cam comprising a cylindrical hub with one or more flats formed thereon; and wherein said leaf spring and said one or more flats are configured to releasably limit pivotal travel of said cam at said first, second, and third positions.

9. The combination locking and tilt latching fastener according to claim 8, further comprising detent means configured to releasably limit pivotal travel of said cam at said first, second, and third positions.

10. The combination locking and tilt latching fastener according to claim 9, further comprising a latch housing configured to receive said latch and said biasing means therein, said latch housing comprising a plurality of teeth configured to sequentially engage the window frame to secure said latch housing to the meeting rail.

11. The combination locking and tilt latching fastener according to claim 10, wherein said lock assembly is configured to be releasably mounted to the meeting rail of the sash window, with said housing of said lock assembly comprising one or more legs, said one or more legs configured to be releasably engaged with respect to one or more corresponding openings in the meeting rail, for said releasable mounting of said lock assembly thereto.

12. The combination locking and tilt latching fastener according to claim 11, said lock assembly comprising a spring configured to secure said one or more legs in said releasable engagement.

13. A combination locking and tilt latching fastener, for use on a frame of a sash window configured to slide and tilt with respect to a master window frame, said fastener comprising:
a lock assembly configured to be mounted to the sash window frame, said lock assembly comprising: a housing; an arm pivotally mounted to said housing and configured to extend into the sash window frame; and a cam pivotally mounted to said housing;
a latch assembly configured to be received through an opening in a side of the hollow sash window frame, said latch assembly comprising a biasing means and a latch member, said latch member comprising a first end formed into a tongue, said biasing means configured to bias said latch member for said tongue to normally protrude out from the sash window frame opening; said latch member comprising a beam extending away from said tongue, said beam comprising a vertical opening through said beam, said beam comprising a post, of a selective length, configured to protrude down from a bottom side of said beam;
wherein said pivotal arm of said lock assembly is configured to be selectively received through said vertical opening in said beam; and
wherein a first position for said pivotal earn is configured to lock the sliding sash window, a second cam position is configured to permit sliding of the sash window, and a third cam position is configured to actuate said pivotal arm to drive said beam of said latch assembly to oppose said biasing, to retract said tongue and permit tilting of the sash window.

14. The combination locking and tilt latching fastener according to claim 13, wherein said selective length of said post of said beam is configured to contact a bottom wall of said sash window frame to support said beam at a substantially central position within the hollow sash window frame.

15. The combination locking and tilt latching fastener according to claim 14, wherein said opening through said beam comprises a rectangular opening with a length of said rectangular opening extending substantially normal to an axial direction of said beam, and with a width of said rectangular opening extending substantially parallel to said axial direction of said beam.

16. The combination locking and tilt latching fastener according to claim 15,
wherein said arm of said lock assembly is formed with an elongated cross-sectional shape having a long-transverse direction and a short-transverse direction,
wherein said arm comprises a protrusion protruding from said arm in said long-transverse direction; and
wherein said pivotal arm of said lock assembly configured to be selectively received through said vertical opening comprises:
said lock assembly with said long-transverse direction of said elongated arm being oriented parallel to said length of said rectangular opening, to be received therethrough; and
said lock assembly thereafter rotated approximately 90 degrees, for said mounting upon the sash window frame, for said long-transverse direction of said arm to thereby be oriented substantially parallel to said width of said rectangular opening, and with a portion of said beam forming said width of said rectangular opening being nested between said protrusion on said elongated arm and said lock housing.

17. The combination locking and tilt latching fastener according to claim 16 wherein said elongated cross-sectional shape comprises a cross-sectional shape from the group of cross-sectional shapes consisting of: a racetrack shape, a clothoid shape, an elliptical shape, and a substantially rectangular shape.

18. The combination locking and tilt latching fastener according to claim 17, further comprising at least a second and a third vertical opening in said beam to form a plurality of said openings spaced along a length of said beam, and at least a second post; and wherein said first and second posts are spaced apart along said length of said beam to support said plurality of openings.

19. The combination locking and tilt latching fastener according to claim 13, said lock assembly further comprising a leaf spring, and said cam comprising a cylindrical hub with one or more flats formed thereon; and wherein said leaf spring and said one or more flats are configured to releasably limit pivotal travel of said cam at said first, second, and third positions.

20. The combination locking and tilt latching fastener according to claim 13, further comprising detent means configured to releasably limit pivotal travel of said can at said first, second, and third positions.

21. The combination locking and tilt latching fastener according to claim 13, further comprising a latch housing configured to receive said latch and said biasing means therein, said latch housing comprising a plurality of teeth configured to sequentially engage the window frame to secure said latch housing thereto.

22. The combination locking and tilt latching fastener according to claim 13, wherein said lock assembly is configured to be releasably mounted to the sash window frame, with said housing of said lock assembly comprising one or more legs, said one or more legs configured to be releasably engaged with respect to one or more corresponding openings in the sash window frame, for said releasable mounting of said lock assembly thereto.

23. The combination locking and tilt latching fastener according to claim 22, said lock assembly comprising a spring configured to secure said one or more legs in said releasable engagement.

24. A combination locking and tilt latching fastener, for use on a frame of a sash window configured to slide and tilt with respect to a master window frame, said fastener comprising:
a lock assembly comprising: a housing configured to be mounted to the sash window frame; an arm pivotally mounted to said housing and configured to extend into the sash window frame; and a cam pivotally mounted to said housing;
a latch assembly configured to be received through an opening in a side of the hollow sash window frame, and comprising a biasing means and a latch member, said biasing means configured to bias said latch member for a portion thereof to normally protrude out from the sash window frame opening; said latch member comprising a vertical through-opening, and a post configured to protrude down a selective length from a bottom side of said latch member, to contact a bottom wall of the meeting rail to support said latch member at a substantially central position within the hollow meeting rail;
wherein said pivotal arm of said lock assembly is configured to be received through said vertical through-opening of said latch member, and to be in close proximity to the bottom wall of the meeting rail to securely couple the latch member thereto; said cam configured to selectively engage said arm to cause said arm to actuate said latch member.

25. The combination locking and tilt latching fastener according to claim 24, wherein said cam is configured to occupy one of at least three positions comprising:
a first cam position configured to lock the sliding sash window;
a second cam position configured to permit sliding of the sash window; and
a third cam position configured for said actuation of said pivotal arm to drive said beam of said latch assembly to oppose said biasing, to retract said tongue and permit tilting of the sash window.

26. The combination locking and tilt latching fastener according to claim 24, wherein said lock assembly is configured to be releasably mounted to the sash window frame, with said housing of said lock assembly comprising one or more legs, said one or more legs configured to be releasably engaged with respect to one or more corresponding openings in the sash window frame, for said releasable mounting of said lock assembly thereto; and said lock assembly comprising a spring configured to secure said one or more legs in said releasable engagement.
